(19) United States
(12) Patent Application Publication
(10) Pub. No.: US 2017/0055117 A1
(43) Pub. Date: Feb. 23, 2017

(54) WIRELESS LOCAL AREA NETWORK FOR AGGREGATED LOCATION

(71) Applicant: Path Intelligence Limited, Portsmouth (GB)

(72) Inventors: Paul Archer, Portsmouth (GB); Leonidas Christodoulou, Portsmouth (GB)

(21) Appl. No.: 14/827,966

(22) Filed: Aug. 17, 2015

(51) Int. Cl. H04W 4/02; H04W 64/00

(52) U.S. Cl. CPC H04W 4/021; H04W 64/006; H04W 4/028

(57) ABSTRACT

A method aggregates a number of visitor mobile devices visiting one or more locations within a facility. The method includes providing a location aggregation network to the facility, transmitting a burst of calibrating probe requests from one or more mobile calibration devices at the one or more locations to one or more of a plurality of receivers in order to calibrate the location aggregation network and form a radio map of the facility. The method further includes intercepting probe requests from a plurality of visitor mobile devices at one or more of the receivers, and comparing at least one physical characteristic of the intercepted probe requests to physical characteristic values of the radio map to yield, associated with the each location for the each receiver, a vector representing a probability that each of the plurality of visitor mobile devices is located at that location.

### TECHNICAL FIELD

The present disclosure relates generally to Wi-Fi based positioning systems; and more specifically, to aggregating a quantity of mobile devices visiting any number of locations within a facility.

### SUMMARY

The present disclosure seeks to provide a method and system for aggregating a quantity of visitor mobile devices visiting one or more locations within a facility.

A method for aggregating a quantity of visitor mobile devices visiting any of a number of locations within a facility, includes providing a location aggregation network, including a plurality of receivers to the facility; transmitting a burst of calibrating probe requests from one or more mobile calibration devices at positions within the number of locations to one or more of the receivers in order to form a radio map of the facility; intercepting probe requests from one or more of the visitor mobile devices at one or more of the receivers; and comparing at least one physical characteristic of the intercepted probe requests to physical characteristic values of the radio map to yield, associated with each of the plurality of receivers, a vector representing a probability for each of the number of locations that a visitor mobile device from which at least one probe request has been intercepted visited those locations.

A system for aggregating a quantity of visitor mobile devices visiting any of a number of locations within a facility includes one or more mobile calibrating devices configured to transmit a burst of calibrating probe requests from positions within the number of locations in order to calibrate the system and form a radio map of the facility; a plurality of receivers configured to receive the calibrating probe requests from one or more of the mobile calibrating devices and intercept probe requests from the visitor mobile devices; and at least one server configured to compare at least one physical characteristic of probe requests intercepted from one or more of the visitor mobile devices to the radio map to yield, associated with each of the plurality of receivers, a vector representing a probability for each of the number of locations that a visitor mobile device from which at least one probe request has been intercepted visited those locations

An additional method for aggregating a quantity of visitor mobile devices visiting any of a number of locations within a facility includes intercepting probe requests from a plurality of visitor mobile devices at a plurality of receivers of a location aggregation network; comparing a received signal strength of probe requests intercepted from one or more of the visitor mobile devices to a received signal strength predictive model to yield, associated with each of the plurality of receivers, a vector representing a probability for each of the number of locations that a visitor mobile device from which at least one probe request has been intercepted visited those locations; and from the probability vectors, computing, for each location, a time-independent probability that any visitor mobile device visits that location during a trip to the facility.

### BRIEF DESCRIPTION OF THE DRAWINGS

The summary above, as well as the following detailed description of illustrative embodiments, is better understood when read in conjunction with the appended drawings. For the purpose of illustrating the systems and methods of the present disclosure, example constructions are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of an example system for aggregating a quantity of mobile devices in accordance with an embodiment of the present disclosure;

FIG. 2 is a schematic illustration of an example system for calibrating a location aggregation network, in accordance with an embodiment of the present disclosure;

FIGS. 3A-13B illustrate steps of example methods for generating a grid dictionary, a grid look up dictionary and a location dictionary, in accordance with an embodiment of the present disclosure;

FIGS. 14A-14B illustrate steps of example methods for finding location of a grid square within a facility, in accordance with an embodiment of the present disclosure;

FIG. 15 illustrates steps of an example method for forming a cluster dictionary for clustering the probe requests received by receivers, in accordance with an embodiment of the present disclosure;

FIGS. 16-22 illustrate steps of an example method for generating a zonal count dictionary, a grid count dictionary, a location count dictionary and an entrance count dictionary, in accordance with an embodiment of the present disclosure;

FIG. 23 illustrates steps of an example method for calculating a visit probability vector of the mobile devices in a particular location of the one or more locations within the facility, in accordance with an embodiment of the present disclosure;

FIG. 24 illustrates steps of an example method for calculating a time ordered synergy, in accordance with an embodiment of the present disclosure;

FIG. 25 is an example plot representing example measured received signal strength (RSS), of the probe requests, as a function of distance, in accordance with an embodiment of the present disclosure;

FIG. 26 is an example plot representing example measured RSS, of the probe requests, as a function of predicted RSS, in accordance with an embodiment of the present disclosure;

FIG. 27 is a schematic illustration of an example system for representing density of visitor mobile devices in one or more locations of the facility, in accordance with an embodiment of the present disclosure; and

FIG. 28 illustrates steps of an example method for aggregating a quantity of visitor mobile devices visiting the one or more locations within the facility, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

In past few years, the use of Wi-Fi based positioning systems has been in great demand for determining the location of mobile devices in indoor environments, particularly for monitoring shopper behavior in shopping centres. Typically, these systems work exploiting the communication between the mobile devices and Wi-Fi access points (for example, routers). Alternatively, information from the mobile devices can be combined with additional data sources, such as known GPS positions to find the location of the mobile device.

Typically, a mobile device communicates with an access point, by sending a probe request, containing the device MAC address. The access point then sends a probe response, containing SSID of the access point. These systems determine the location of the device with respect to the access point, which essentially require knowledge of the locations of the access point. Additionally, these systems may not provide accurate results due to number of biases that may arise while calculating the result, such as when a user spends longer time in one shop than another and the like.

Therefore, in light of the foregoing discussion, there exists a need to overcome the aforementioned drawbacks of the conventional Wi-Fi based positioning systems.

Embodiments of the present disclosure substantially eliminate or at least partially address the aforementioned problems in the prior art, and enables aggregation of the number of visitor mobile devices visiting the one or more locations within the facility.

The following detailed description illustrates embodiments of the present disclosure and ways in which they can be implemented. Although some modes of carrying out systems and methods of the present disclosure have been described, those skilled in the art would recognize that other embodiments for carrying out or practicing methods and systems of the present disclosure are also possible. Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

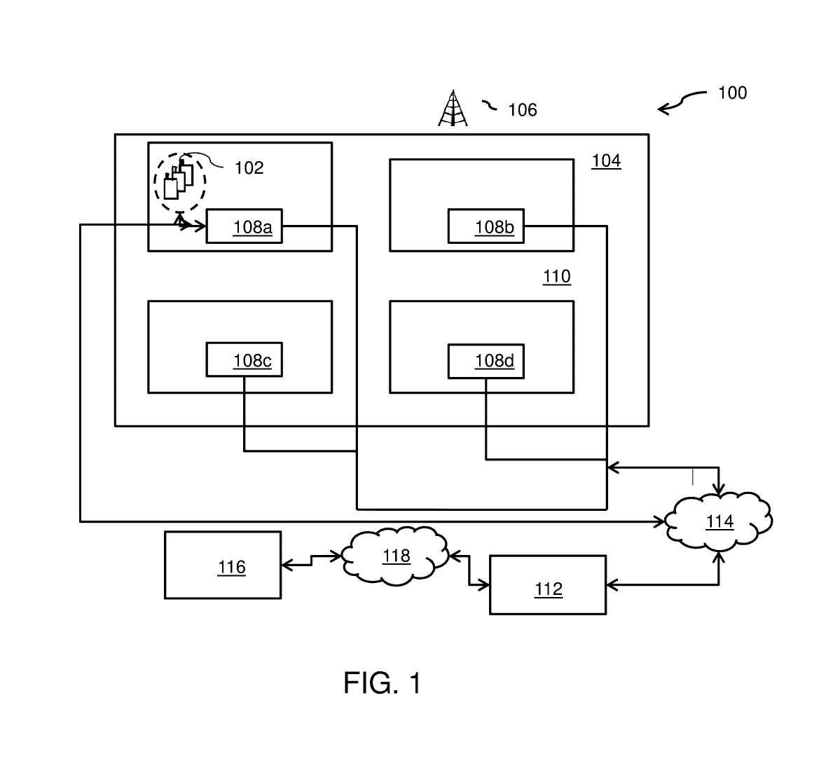

Referring to FIG. 1, illustrated is an example schematic of a system 100 for aggregating a quantity of visitor mobile devices 102 visiting one or more locations within a facility 104, in accordance with an embodiment of the present disclosure. The system 100 includes a number of receivers 108a-d provided to facility 104 and employed in a location aggregation network 110, a server 112 communicably coupled to each of the receivers 108a-d, a network 114 communicably coupling the receivers 108a, 108b, 108c, 108d (hereinafter referred to as 108a-d) with the server 112, an external computer 116 and a network 118 communicably coupling the server 112 with the external computer 118. Optionally, the system 100 includes a wireless base station 106 that communicates with the visitor mobile devices 102. Alternatively, the wireless base station 106 can be any wireless device capable of communicating with the visitor mobile devices 102.

In an embodiment, each of the visitor mobile devices 102 can be a smart phone, a tablet, a phablet or the like. In an embodiment, the facility 104 is a shopping centre/mall and the one or more locations in the facility 104 may include but are not limited to stores, corridors, cafes/restaurants, gaming areas, sports bars or the like. In other embodiments, the facility 104 can be a hospital, railway station, airport, hotel or resort, control room for monitoring battlefields or the like. Further, in an embodiment, each of the visitor mobile devices 102 is associated with a shopper who visits the one or more locations within the facility 104.

As described, the receivers 108a-d are employed in the location aggregation network 110 of the facility 104 and are capable of receiving wireless transmissions from the visitor mobile devices 102 including but not limited to GSM, CDMA, Bluetooth and Wi-Fi. Further, the receivers 108a-d are configured to continuously scan the location aggregation network 110 and search for the visitor mobile devices 102 in order to obtain their respective unique identifier. For example, this unique identifier in GSM could be the mobile device's IMSI, TIMSI or IMEI. For Bluetooth or Wi-Fi, the unique identifier could be the mobile device's MAC address. In an embodiment, unique identifiers are the MAC addresses of the visitor mobile devices 102.

In an embodiment, the server 112 is a control unit that receives and stores data from the receivers 108a-d via the network 114. Data may include, but is not limited to, the unique identifier, time of communication, and/or other related information. Network 114 may employ Ethernet and/or Wi-Fi but is not limited to these. According to an embodiment, the server 112 is pre-informed of the locations of the receivers 108a-d. According to another embodiment, the receivers 108a-d independently transmit information regarding their locations to the server 112.

According to an embodiment, the server 112 can be accessed by an external computer 116 via the network 118. At any time, the external computer 116 can connect via the network 118 to the server 112 to query stored data and perform further processing on the data as required. Network 118 may also employ Ethernet and/or Wi-Fi but is not limited to these. According to another embodiment, the server 112 may be self-supporting and not be accessed by the external computer 116.

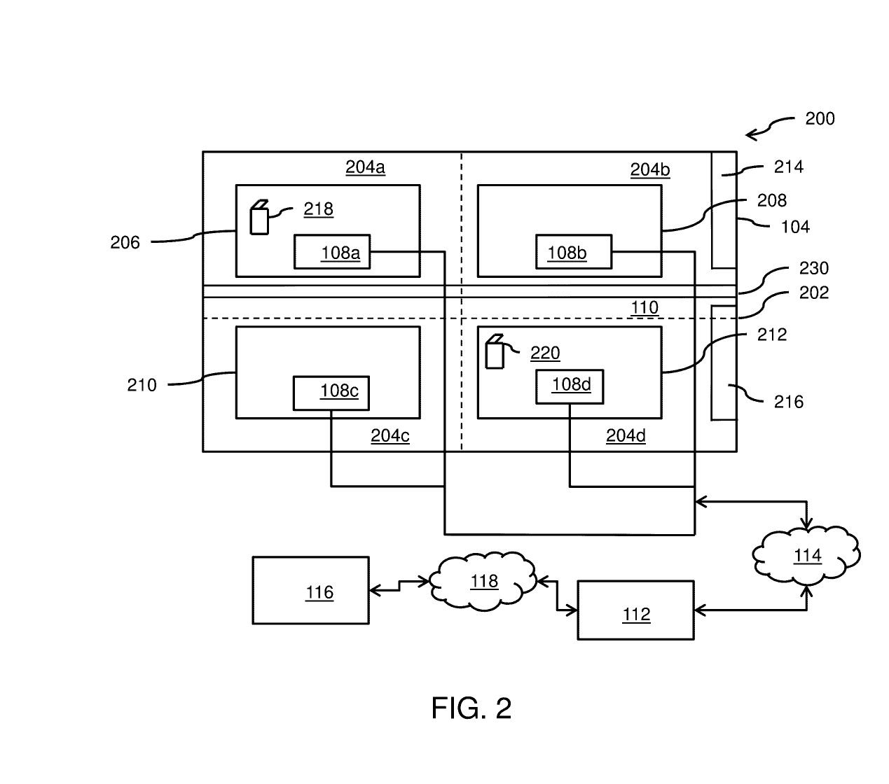

Now referring to FIG. 2, illustrated is a schematic of a system 200 for calibrating the location aggregation network 110, in accordance with an embodiment of the present disclosure. Calibration may be performed by building a scalar vector graphics (SVG) map 202 of the facility 104 and using it to form a radio map. Calibration of the location aggregation network 110 facilitates accurately aggregating the number of visitor mobile devices 102 visiting the one or more locations.

The SVG map 202 shows the facility 104, which is divided into even size grid squares, such as grid squares 204a-d. Each grid square 204a-d, which may be as small as desired as limited by processing power, corresponds with a respective location, such as a location 206, 208, 210 and 212. While any relative sizing between grid squares and locations of the facility may be implemented, in an example each location is represented by at least one grid square. In an embodiment, each location includes corresponding at least one of receivers 108a-d. Further, the facility 104 includes an entrance 214 and an exit 216 which are also encompassed or partially encompassed by grids 204a-d. Further, the SVG map 202 shows physical quantities or attributes of the facility 104 including distance, walls 230 and floors, between a grid square and a receiver, such as the grid square 204a and the receiver 108a. Additionally, the attributes may be number of floors in the facility 104, number of stores in the facility 104 and the like.

Further, the system 200 includes one or more mobile calibrating devices, such as mobile calibrating devices 218, 220. The mobile calibrating devices 218, 220 may include but are not limited to smart phones, tablets and phablets hosting a custom built mobile phone application which forces the devices 218, 220 to emit bursts of calibrating probe requests from known locations, for example, during a calibrating walk around the facility 104 among locations 206-212 Preferably, the mobile calibrating devices transmit Wi-Fi probe requests.

The receivers 108a-d, communicably coupled to the mobile calibrating devices 218, 220, are configured to receive the calibrating probe requests from the mobile calibrating devices 218, 220. In an embodiment, each of the receivers 108a-d is capable of receiving the probe requests from the mobile calibrating devices 218, 220 up to an area. For example, receiver 108a is capable of receiving probe requests from mobile calibrating device 218 since both are positioned within grid square 204a. Further, receivers 108a-d may be placed up to 200 meters apart in a pattern throughout in the location aggregation network 110. It may be noted that the area from which the receivers 108a-d are sensitive to receive signals is quite large as compared to the spacing between the receivers 108a-d. Accordingly, more than one receiver of the receivers 108a-d is sensitive to receive signals from any given position within the locations, and there is a relatively large area that is covered by all of the receivers 108a-d.

In an embodiment, the receivers 108a-d are synchronized to each other and are able to scan the available spectrum for signals (Wi-Fi probes) from the mobile calibrating devices 218, 220 sufficiently quickly so that each device is monitored reasonably frequently. This ensures that the mobile calibrating devices 218, 220 are detected by at least two different receivers within a suitably short period of time. If the circumstances are such that this is not possible, then it is advantageous to synchronize the scanning performed by the receivers 108a-d so that the probe requests from a mobile calibrating device can be detected by multiple receivers within a suitably short period of time.

Further, each of the receivers 108a-d is configured to cluster the probe requests received from each of the mobile calibrating devices 218, 220 to group those signals that are received by the same receiver and at approximately the same time. Alternatively, the server 112 can be configured to cluster the probe requests received by each of the receivers 108a-d to group the signals. A dedicated clustering algorithm is used to group such signals together. In an example, signals are grouped together according to agglomerative hierarchical clustering based on time between pings. This employs the cophenetic distance. In another example, which employs clustering with a hard cut-off, all signals within a fixed interval of the first signal are grouped together

Further, the server 112 uses calibration data (data corresponding to the calibrating probe requests, such as MAC address of the mobile calibrating devices 218, 220) from the receivers 108a-d to form a radio map of the facility 104. Additionally, the server 112 uses the calibration data to fit a model for predicting the received signal strength (RSS) of the visitor mobile devices 102. Further, the model is formed by the server 112 based on calculating, from the SVG map 202, the number of physical quantities, such as distance, number of walls and number of floors, between a grid square and a receiver, such as the grid square 204a and the receiver 108a.

In addition, the server 112 is further configured to, during formation of the radio map, impose these attributes of the SVG map 202 to the radio map. Specifically, the server 112 uses the information from the SVG map 202, (such as the distance, number of walls and number of floors, between a grid square and a receiver, such as the grid square 204a and the receiver 108a) to fit the model. In an embodiment, each location of each of the mobile devices is represented on the radio map with a fingerprint.

Typically, the server 114 fits the model based on linear regression, according to which the server 112 predicts the RSS of the visitor mobile devices 102 and consequently determines the aggregated number of the visitor mobile devices 102 visiting the one or more locations. Based on the linear regression, the calculated values of the physical quantities of the SVG map 202 act as independent variables (X-variables), which are associated with the calibration data to predict the aggregated number of the visitor mobile devices 102 visiting the one or more locations.

Further, as the linear regression based model uses the values of the physical quantities of the SVG map 202, it is therefore robust against various biases and skews arising in the calibration data. By fitting to a pseudo-physical model in the form of the SVG map, biases are mitigated and the obtained estimate of anticipated variation in RSS is more accurate as being based on the entire calibration data set rather than just a small number of points from a signal location. For example, if a calibrator spends 5 minutes in a location within the facility and is not seen on a receiver, then if there are 10 walls between the mobile calibration device and the receiver it is likely that location is not visible to the receiver. As an additional feature of fitting RSS data to an SVG map, it is possible to generate radio map information for any location within a facility regardless of whether it has been calibrated. Working with a system of equally-sized grid squares reduces the bias between big locations and small locations within the facility.

Further, the model is capable of predicting the RSS within a calculable accuracy of around 5 dB. In an example, the server 112 uses a Markov Chain Monte Carlo to fit the model, based on Bayesian inference, thereby making the model robust against different skews and biases. The inaccuracy and biases may arise, for example, when multiple locations have the same fingerprint or position on the radio map, when a user spends longer time in one shop than another, when the shops are of different size, when the user is in an uncalibrated location and the like. Further, the at least one server, such as the server 112 is further configured to quantify a bias due to two or more of the locations having a given fingerprint by calculating the Bhattacharyya distance between different locations to estimate the reliability of a given count.

In an instance, when one or more of the visitor mobile devices 102 enter the facility 104, these devices transmit the Wi-Fi probe requests. The at least one receiver from the receivers 108a-d intercepts these Wi-Fi probe requests and consequently calculates the RSS of the corresponding visitor mobile devices 102. In an example, the RSS of the visitor mobile devices 102 is calculated as an integer value.

Each of the receivers 108a-d are further configured to filter out, from the intercepted visitor mobile device probe requests, signals from devices passing by the facility 104, randomized MAC addresses and signals from fixed devices (EPOS). Specifically, each of the receivers 108a-d are configured to filter the probe requests and remove those which are estimated not to originate from mobile devices present within the facility 104, such as signals received from mobile devices passing by the centre. Alternatively, the server 112 can also be configured to filter out these types of signals.

Additionally, the receivers 108a-d re configured to cluster the intercepted probe requests according to the MAC address. In an example, the receivers 108a-d cluster and group the filtered data, such that for each MAC address, a list of clusters and the time at which the probe requests were received by the receivers 108a-d are obtained. Alternatively, the server 112 can also be configured to cluster the intercepted probe requests according to the MAC address.

According to an embodiment, the receivers 108a-d perform the clustering based on time of detection. Specifically, the signals detected within a certain time interval (typically 60 seconds) are grouped together. According to another embodiment, the server 112 performs the clustering based on angle between probability vectors (described later). Specifically, if the angle between the two probability vectors in a probability space is less than a threshold angle, then the vectors are deemed to have originated from the same location and are thus, grouped together. According to yet another embodiment, the server 112 performs the clustering based on both the time at which the clusters of signals are detected and the angle between the probability vectors. Typically, a single cluster comprises a list of receivers (such as, the receivers 108a-d) and corresponding measured RSS. In an embodiment, the server 112 determines a probable location of that cluster by employing a plurality of calculated dictionaries (described below). In an embodiment, grouping the clusters together improves the accuracy of the predicted location.

Further, for a given cluster of signals, the server 112 estimates the probability of a source being in each grid square using Bayes theorem to form a normalized probability vector, running over all the grid squares. Specifically, the server 112 is configured to relate/compare the at least one physical characteristic of the intercepted probe requests to the received signal strength predictive model to yield, associated with each location for each receiver, a vector representing a probability that each of the plurality of visitor mobile devices 102 is located at that location. In an embodiment, the at least one physical characteristic of the intercepted probe requests can be the received signal strength (RSS) of the visitor mobile devices 102. The probability that a MAC address has visited a location is calculated iteratively using:

P(V|p₁)=P(L|p₁)

P(V|p_{1 . . . n})=P(L|pₙ)+(1−P(L|pₙ))·P(V|p_{1 . . . n-1})

### Where,

pᵢ (p₁ . . . pₙ) denotes grouped signals of a user (identified by, for example, MAC address) associated to a time interval

P(L|pᵢ) denotes probability of being in a location given a set of signals pᵢ

P(V|p_{1 . . . n}) denotes probability of visiting a location given all sets of signals pᵢ to Pₙ.

Because of the possibility of multiple probe requests from a single phone during the user's presence in a location and resulting imperfections in movement determination, time based clustering often leads to over estimation of the number of locations visited. Thus, in an embodiment, location based reporting is time independent, which significantly reduces the over estimation of the number of visited locations and yields a time independent probability that a user (identified by, for example, MAC address) visited a location at some point during their trip to the facility 104. Going further, visit probability for a given location is determined by an aggregation over sets of signals from multiple users. In an embodiment, the server 112 is configured to compute time-independent probabilities.

Further, in another embodiment, the server 112, is further configured to compute, from the probability vectors, the number of visitor mobile devices 102 which visited a first of the one or more locations and subsequently visited a second of the one or more locations. Specifically, the server 112 computes the time dependent synergy by using the probability that a user visited first location L^{1st} and then location L^{2nd}, at some point during their trip:

$$p ( {V}^{{1}^{st}} {V}^{{2}^{nd}} \vert {p}_{1 … n} ) = P ( {L}^{{1}^{st}} \vert {p}_{1} ) P ( {V}^{{2}^{nd}} \vert {p}_{2 … n} ) + {\sum }_{j = 2}^{n - 1} P ( {L}^{{1}^{st}} \vert {p}_{j} ) ( 1 - P ( {V}^{{1}^{st}} \vert {p}_{1 … j - 1} ) ) P ( {V}^{{2}^{nd}} \vert {p}_{j + 1 … n} )$$

The server 112 may be configured to calculate a look up dictionary, running over each of the receivers 108a-d and the power, with the corresponding probability vectors. The look up dictionary may include a plurality of dictionaries, such as, a location (units) dictionary, a receiver dictionary, a grid look-up dictionary, a grid dictionary, a zone dictionary, an entrance dictionary and the like.

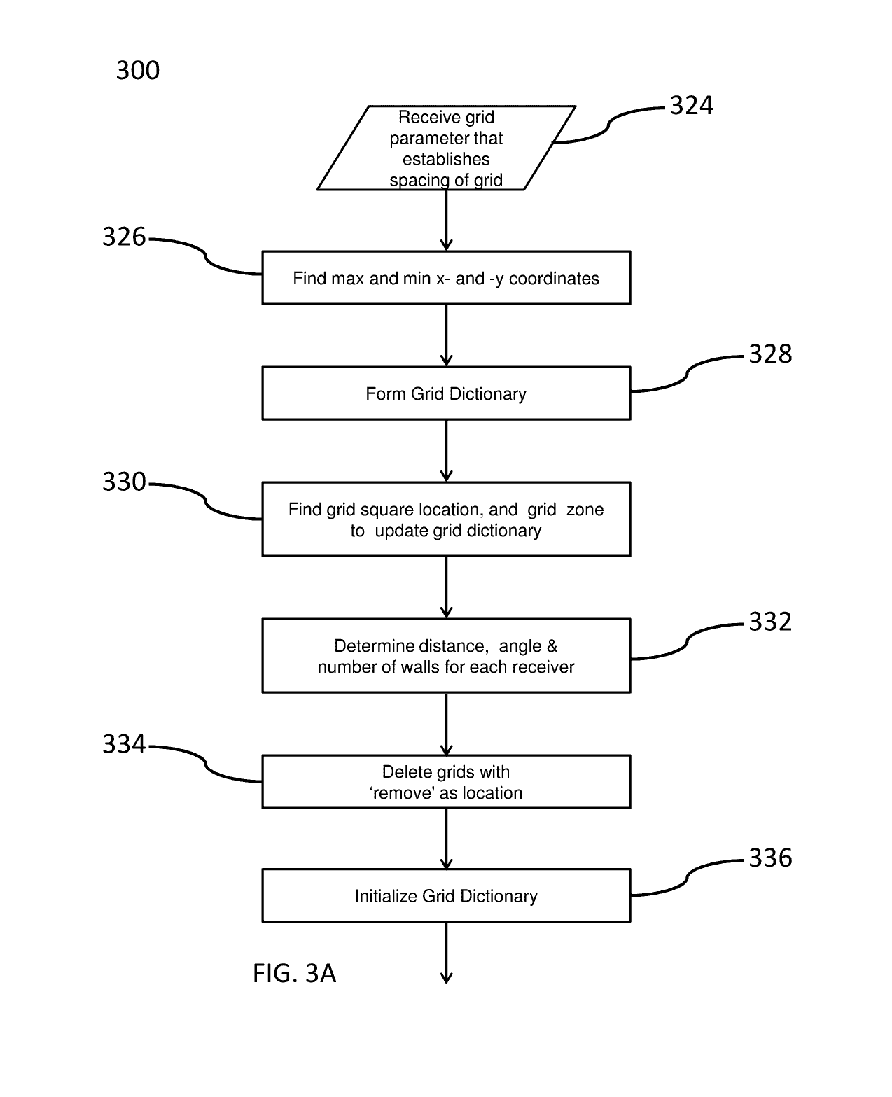

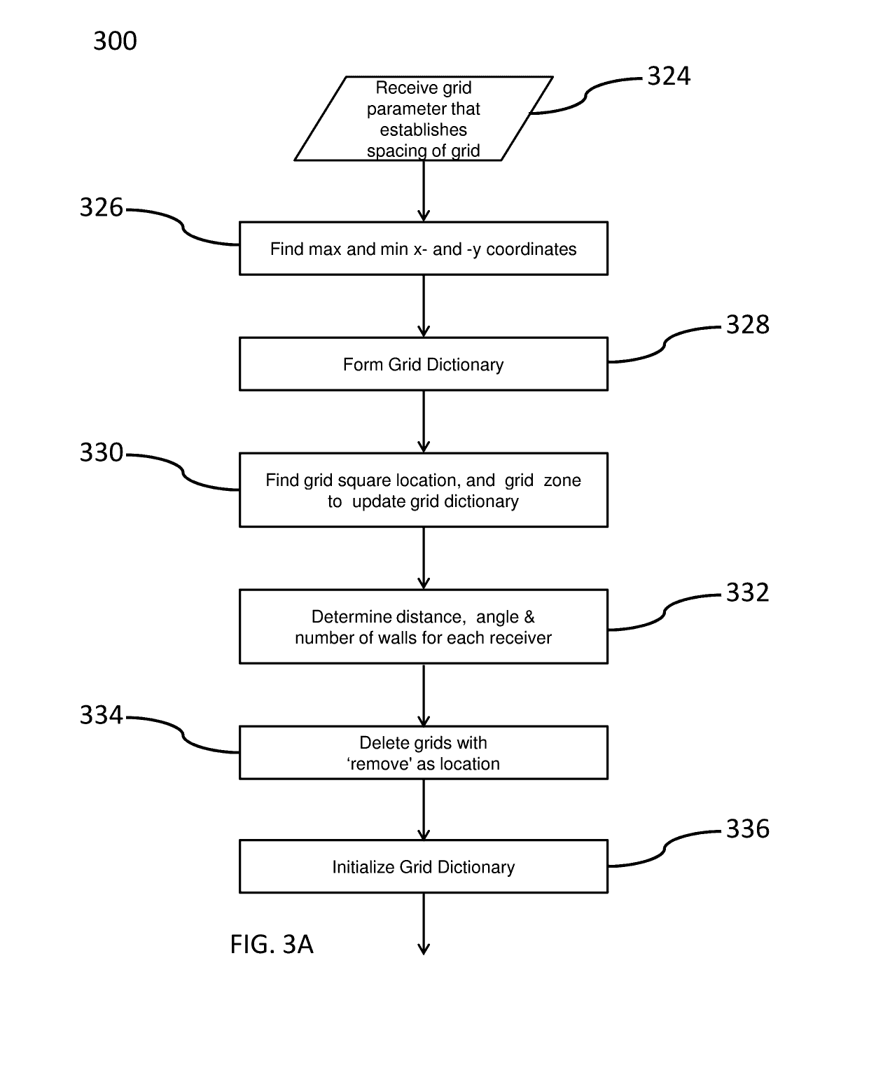

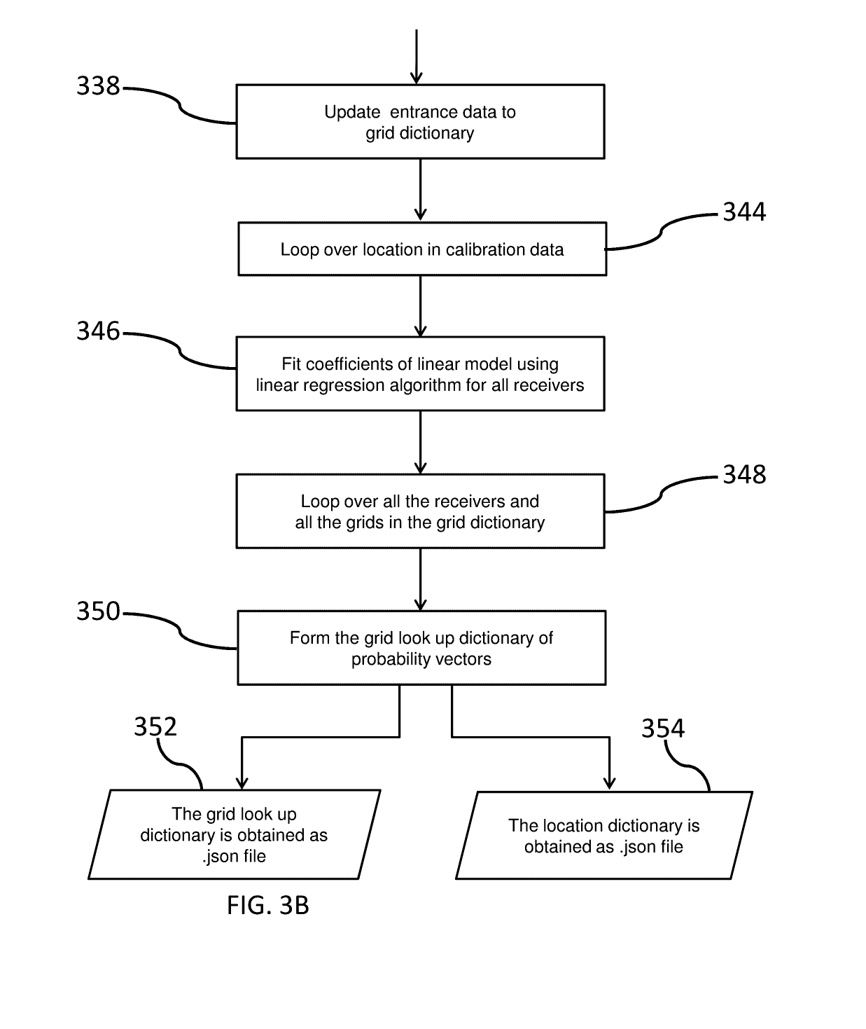

Referring to FIGS. 3A-13B, illustrated example processes for generating the grid dictionary, the grid look-up dictionary and the location dictionary, in accordance with an embodiment of the present disclosure. Those skilled in the art would recognize that the example processes illustrate example actions involved in the operation of a system such as system 200. It should be further recognized that these figures are only illustrative and other alternatives can also be implemented where one or more actions among those illustrated in one of FIGS. 3A-13B may be traded with one or more actions of another of FIGS. 3A-13B. Furthermore one or more actions may be added, one or more actions may be removed, and/or one or more actions may be provided in a different sequence without departing from the scope of the claims herein.

Referring to FIGS. 3A-3B, illustrated are actions of a first example process for generating the grid dictionary, the grid look-up dictionary and the location dictionary. At 324, the server 112 receives a parameter establishing spacing of grid. At 326, the server 112 loops over the map data to find the range among the coordinates representing all of the locations. At 328, the server 112 forms the grid dictionary by adding coordinates of the grid squares. At 330, the server 112 finds location of a grid square using a sub-routine and thereby determines zone of the grid square, and further updates it to the grid dictionary.

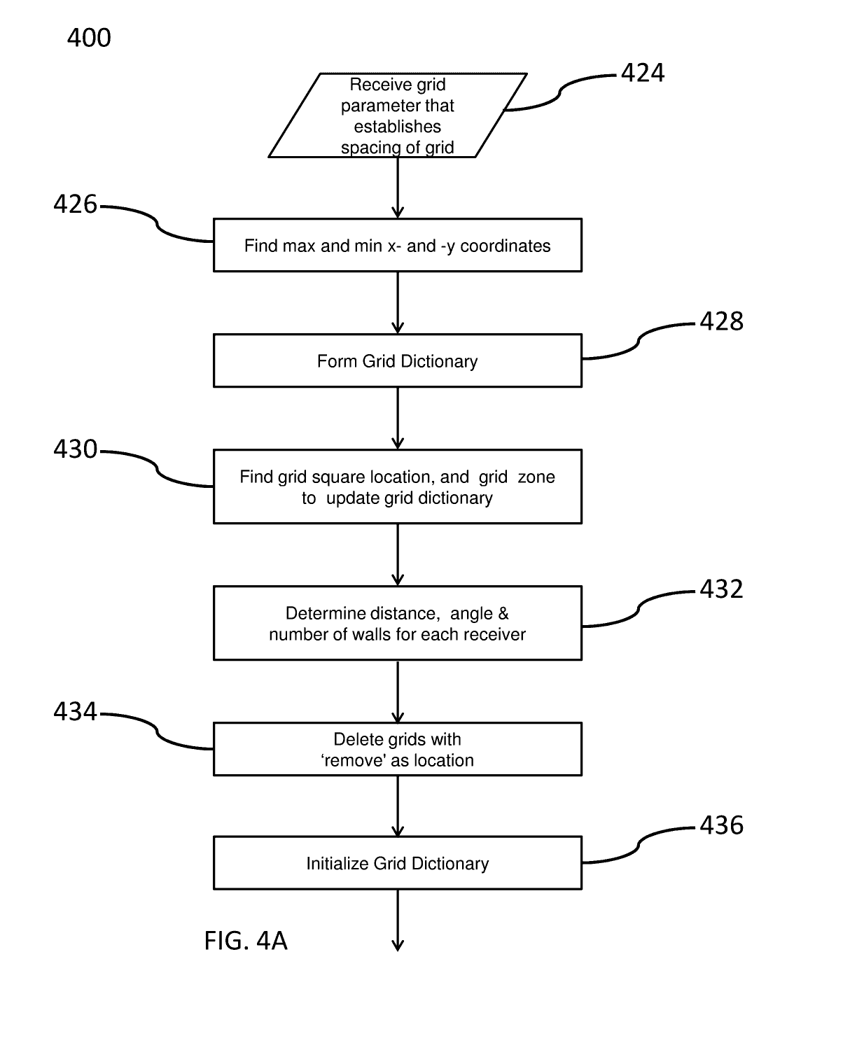

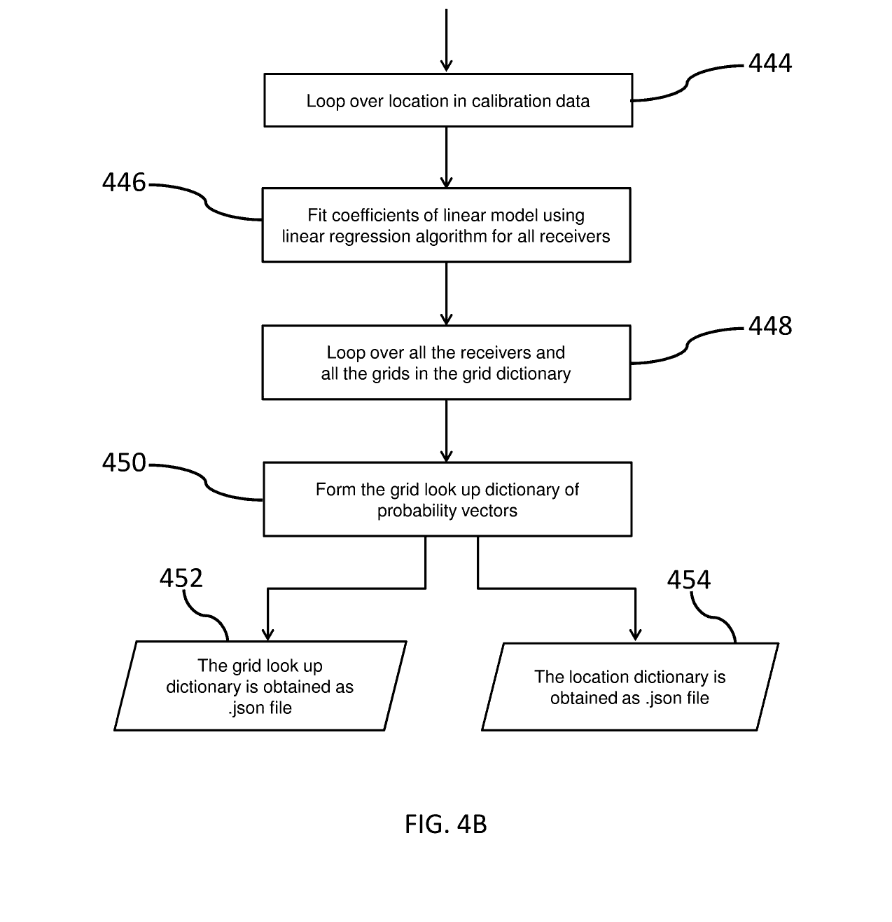

At 332, the server 112 finds, for each receiver in the receiver dictionary, the distance between the grid square and the receiver, the angle between the grid square and the receiver, the number of walls between the grid square and the receiver and then updates each to the grid dictionary. Further, at 334, the server 112 deletes the grid squares exterior to the facility or other perimeter of interest. Such grid squares may be set to ‘remove’ status. At 336, the server 112, for each grid square, loops over the entrance dictionary by finding distance to the grid square, determining nearest entrance, updating the entrance to the grid dictionary and forming the list of nearest grid squares for the each entrance (described in detail below with reference to FIGS. 4A-4B).

At 338, the server 112 finds the minimum number of grid squares running over all entrances of the facility 104. Further, for each entrance and for a number of nearest grid squares, the server 112 updates, to the grid dictionary, data related to each entrance.

At 344, the server 112 loops over location in calibration data, grouping calibration data by location and then clustering the data for each location. Further, the server 112 is configured to append power (RSS) of the probe request to the OLS data dictionary and a power error to the OLS data dictionary. Further, the server 112 is configured to look up distance, walls crossed and an angle from the grid square to the receiver, find difference in floors between the grid square and the receiver, append to X-variables (mentioned above with reference to FIG. 2), pass X-variables through choice of ansatz model and finally append to X-variables.

At 346, the server 112, for all the receivers, fits coefficients of a linear model using a linear regression algorithm, uses cross validation to estimate standard error, counts number of clusters per receivers and updates to the OLS model dictionary. Further, if the server 112 finds that the receiver has less than 10 clusters, then the server 112 computes a mean over other receivers. At 348, the server 112 loops over all the grid squares in the grid dictionary, all the receivers, and look up the X-variables for grid squares (for example, distance, walls, angle, and the like) from the grid dictionary. As such, a normal distribution of the expected RSS measured at each receiver is formed. Further, the server 112 is configured to find variables for the model, look up the model for the receiver and calculate a predicted RSS for the grid square and the receiver.

At 350, the server 112 forms the grid look-up dictionary of probability vectors, over all the grid squares and for every possible power and receiver. At 352 and 354, both the grid look up dictionary and the location dictionary are obtained as .json file respectively.

Referring to FIGS. 4A-4B, illustrated are actions of a second example process for generating the grid dictionary, the grid look-up dictionary and the location dictionary. As with process 300 at 324, at 424, the server 112 receives a parameter establishing spacing of grid and at 426, the server 112 loops over the map data to find the range among the coordinates representing all of the locations. At 428, the server 112 forms the grid dictionary by adding coordinates of the grid squares. At 430, the server 112 finds location of a grid square using a sub-routine and thereby determines zone of the grid square, and further updates it to the grid dictionary as mentioned above.

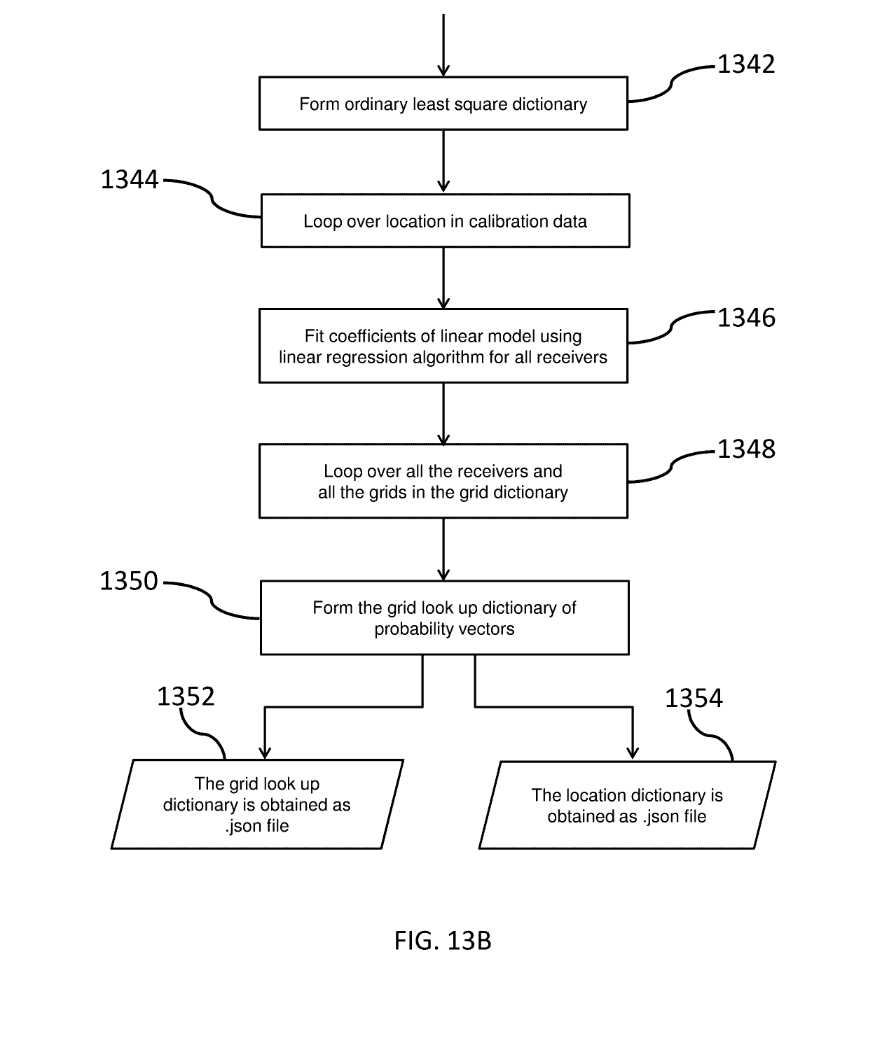

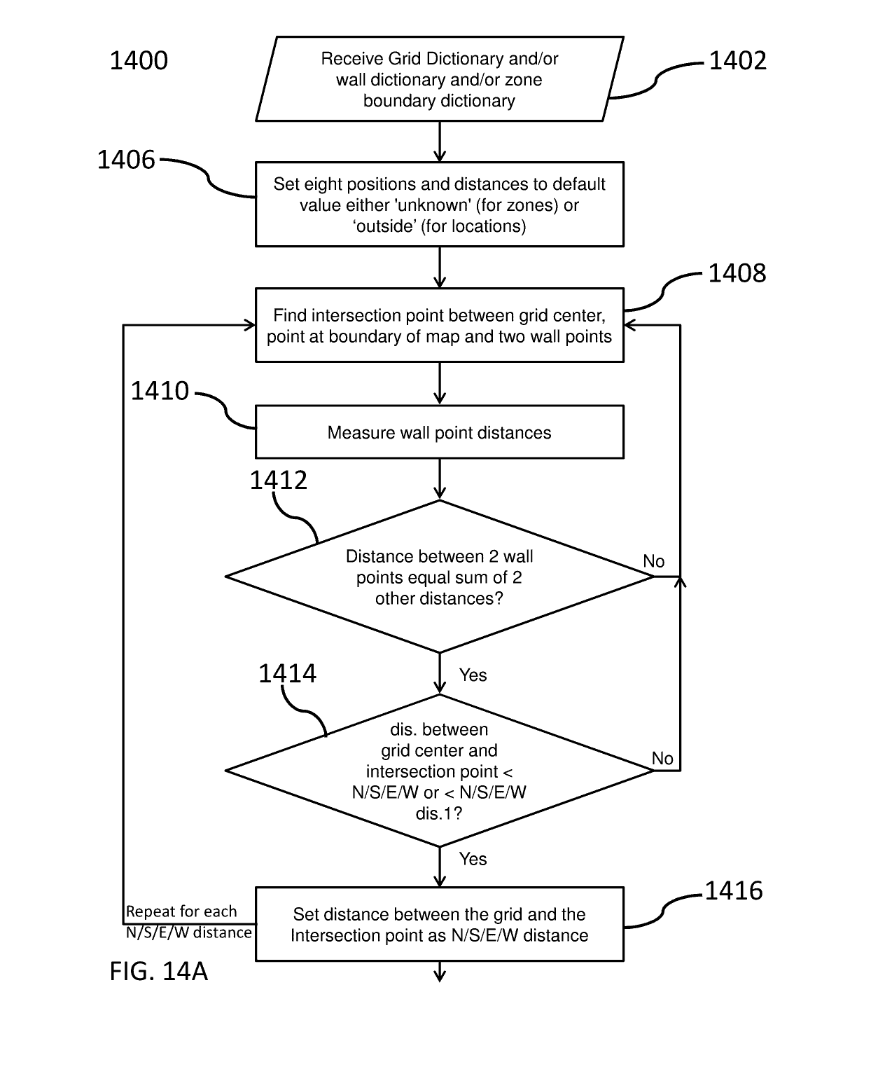

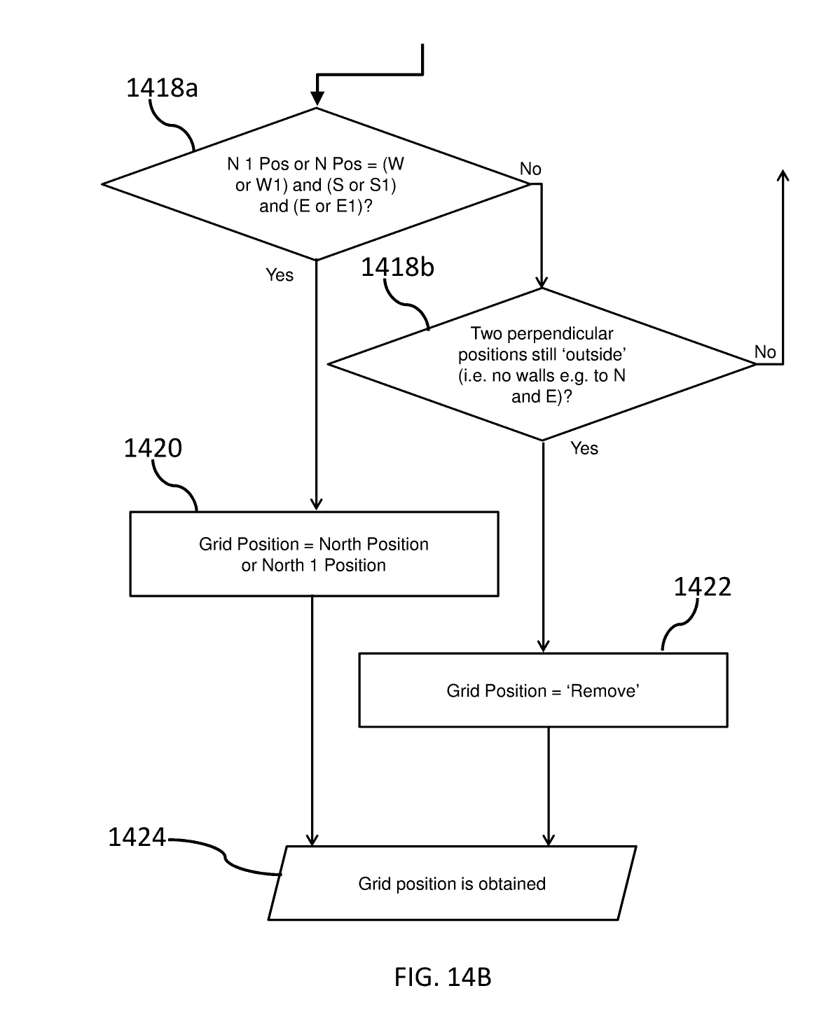

At 432, the server 112 finds, for each receiver in the receiver dictionary, the distance between the grid square and the receiver, the angle between the grid square and the receiver, the number of walls between the grid square and the receiver and then updates each to the grid dictionary. Further, at 434, the server 112 deletes the grid squares exterior to facility or other perimeter of interest. At 436, the server 112, for each grid square, loops over the entrance dictionary by finding distance to the grid square, determining nearest entrance, updating the entrance to the grid dictionary and forming the list of nearest grid squares for the each entrance (described in detail below with reference to FIGS. 14A & 14B).

Rather than proceeding to update entrance data to the grid dictionary process 400 skips to the server 112 looping over location in calibration data, grouping calibration data by location and then clustering the data for each location at 444. As with process 300, the server 112 is configured to append power (RSS) of the probe request to the OLS data dictionary and a power error to the OLS data dictionary. Additionally, the server 112 is configured to look up distance, walls crossed and an angle from the grid square to the receiver, find difference in floors between the grid square and the receiver, append to X-variables (mentioned above with reference to FIG. 2), pass X-variables through choice of ansatz model and finally append to X-variables.

At 446, the server 112, for all the receivers, fits coefficients of a linear model using a linear regression algorithm, use cross validation to estimate standard error, count number of clusters per receivers and update to the OLS model dictionary. Further, if the server 112 finds that the receiver has less than 10 clusters, then the server 112 computes a mean over other receivers, as described above. At 448, the server 112 loops over all the grid squares in the grid dictionary, loops over all the receivers, and looks up the X-variables for grid square to form a normal distribution of the expected RSS measured at each receiver. Further, the server 112 is configured to find variables for the model, look up the model for the receiver and calculate a predicted RSS for the grid square and the receiver.

At 450, the server 112 forms the grid look-up dictionary of probability vectors, over all the grid squares and for every possible power and receiver. At 452 and 454, both the grid look up dictionary and the location dictionary are obtained as .json file respectively.

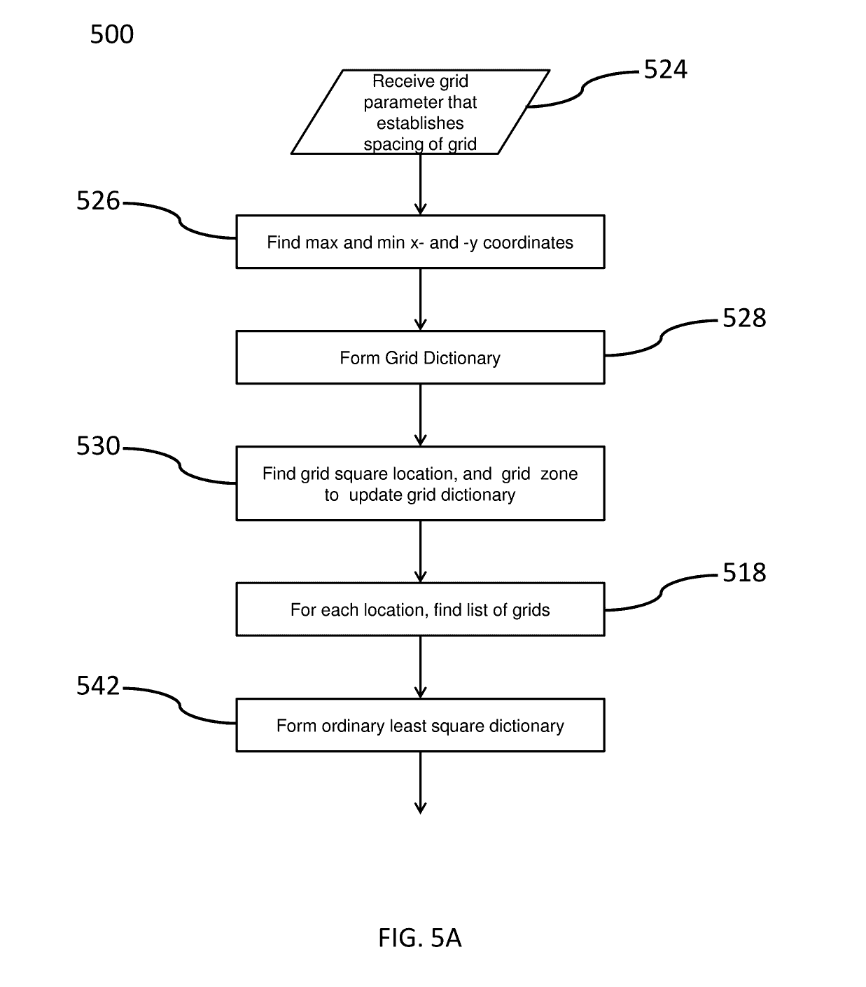

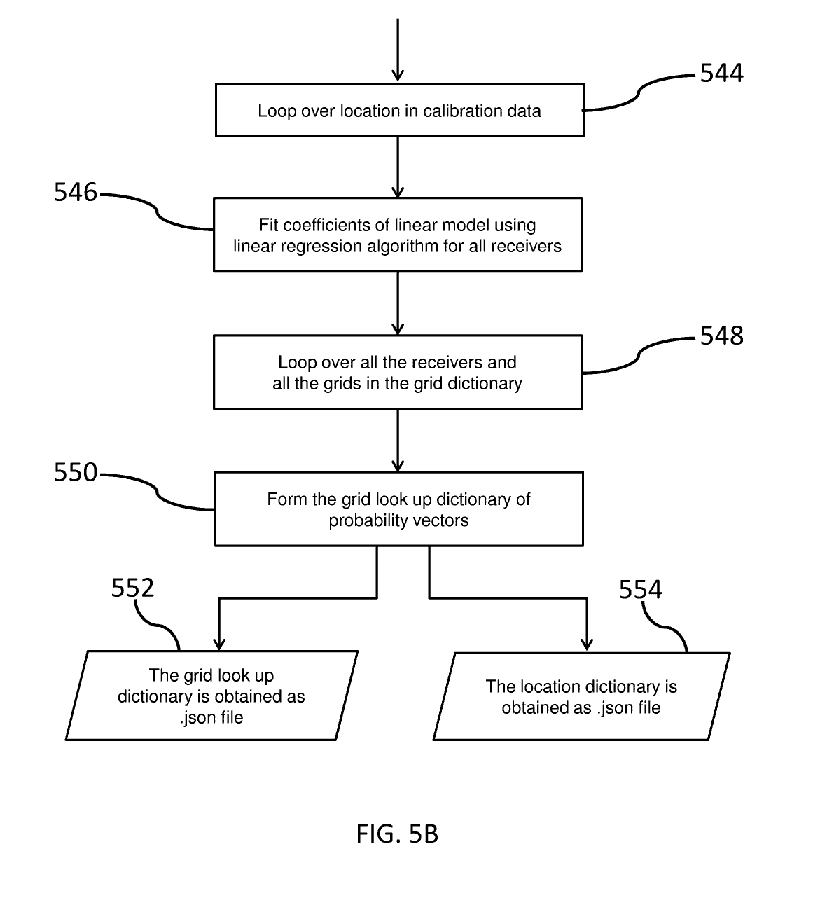

Referring to FIGS. 5A-5B, illustrated are actions of a third example process for generating the grid dictionary, the grid look-up dictionary and the location dictionary. At 524, the server 112 receives a parameter establishing spacing of grid. At 526, the server 112 loops over the map data to find the range among the coordinates representing all of the locations. At 528, the server 112 forms the grid dictionary by adding coordinates of the grid squares. At 530, the server 112 finds location of a grid square using a sub-routine and thereby determines zone of the grid square, and further updates it to the grid dictionary as mentioned above.

Next, at 518, for each location (unit) the server 112, loops over the grid dictionary in order to find a list of grid squares in each unit. Further, the server 112 produces data points fit to produce a model for RSS. Thus, at 542, the server 112 forms an ordinary least square dictionary (OLS data dictionary) which contains data for linear regression. At 544, the server 112 loops over location in calibration data, grouping calibration data by location and then clustering the data for each location. As with the processes 300 and 400, the server 112 is configured to append power (RSS) of the probe request to the OLS data dictionary and a power error to the OLS data dictionary. Further, the server 112 is configured to look up distance, walls crossed and an angle from the grid square to the receiver, find difference in floors between the grid square and the receiver, append to X-variables (mentioned above with reference to FIG. 2), pass X-variables through choice of ansatz model and finally append to X-variables.

At 546, the server 112, for all the receivers, fits coefficients of a linear model using a linear regression algorithm, use cross validation to estimate standard error, count number of clusters per receivers and update to the OLS model dictionary. Further, if the server 112 finds that the receiver has less than 10 clusters, then the server 112 computes a mean over other receivers, as described above. At 548, the server 112 loops over all the grid squares in the grid dictionary, loop over all the receivers, to form a normal distribution of the expected RSS measured at each receiver. Further, the server 112 is configured to find variables for the model, look up the model for the receiver and calculate a predicted RSS for the grid square and the receiver.

At 550, the server 112 forms the grid look-up dictionary of probability vectors, over all the grid squares and for every possible power and receiver. At 552 and 554, both the grid look up dictionary and the location dictionary are obtained as .json file respectively.

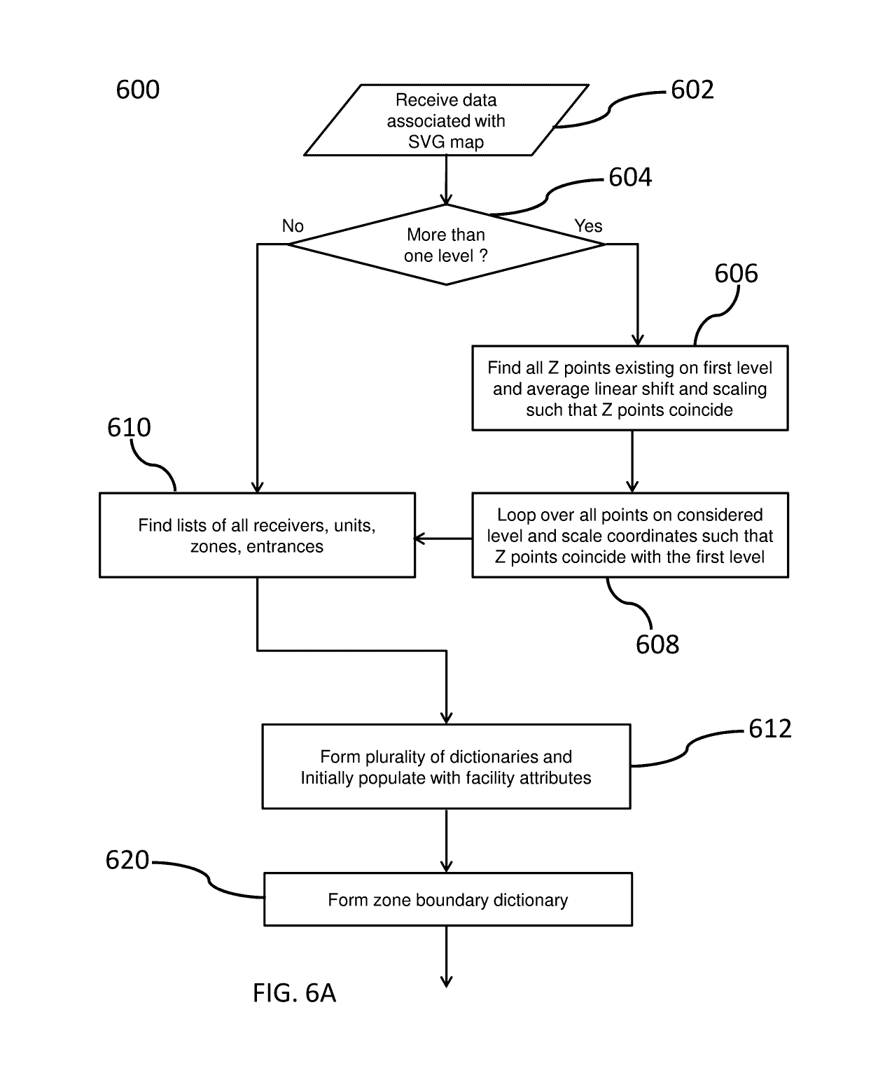

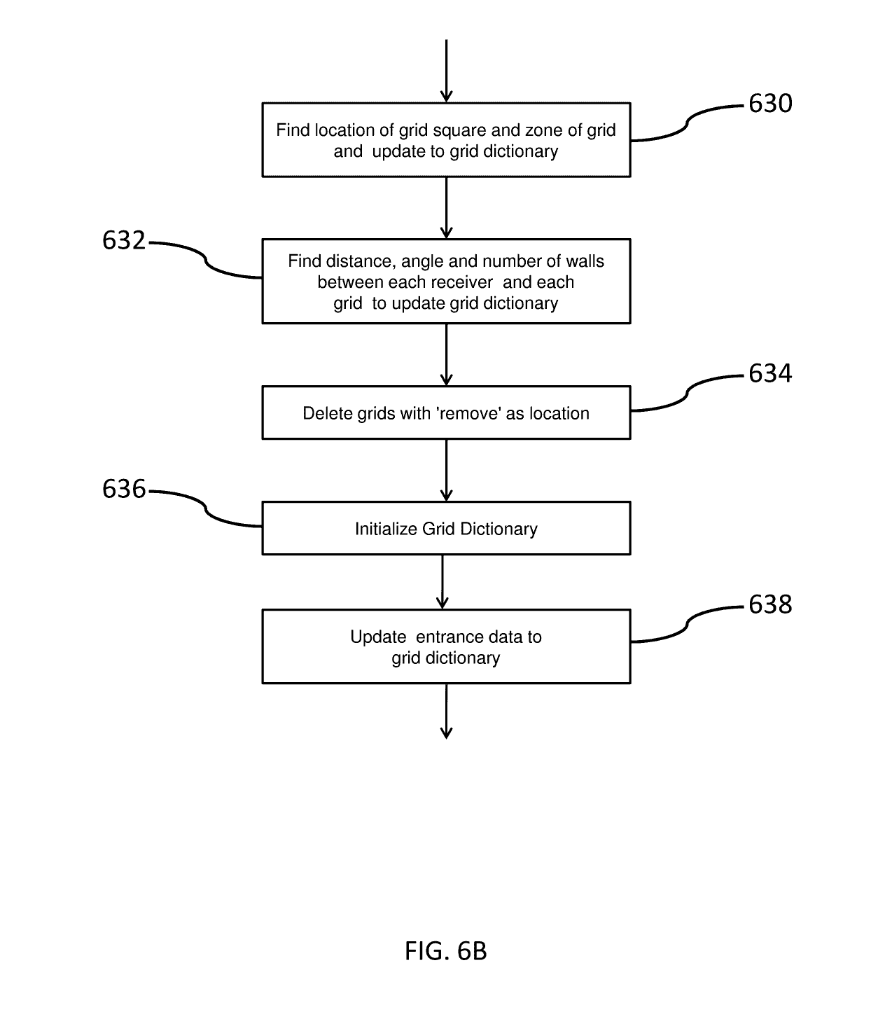

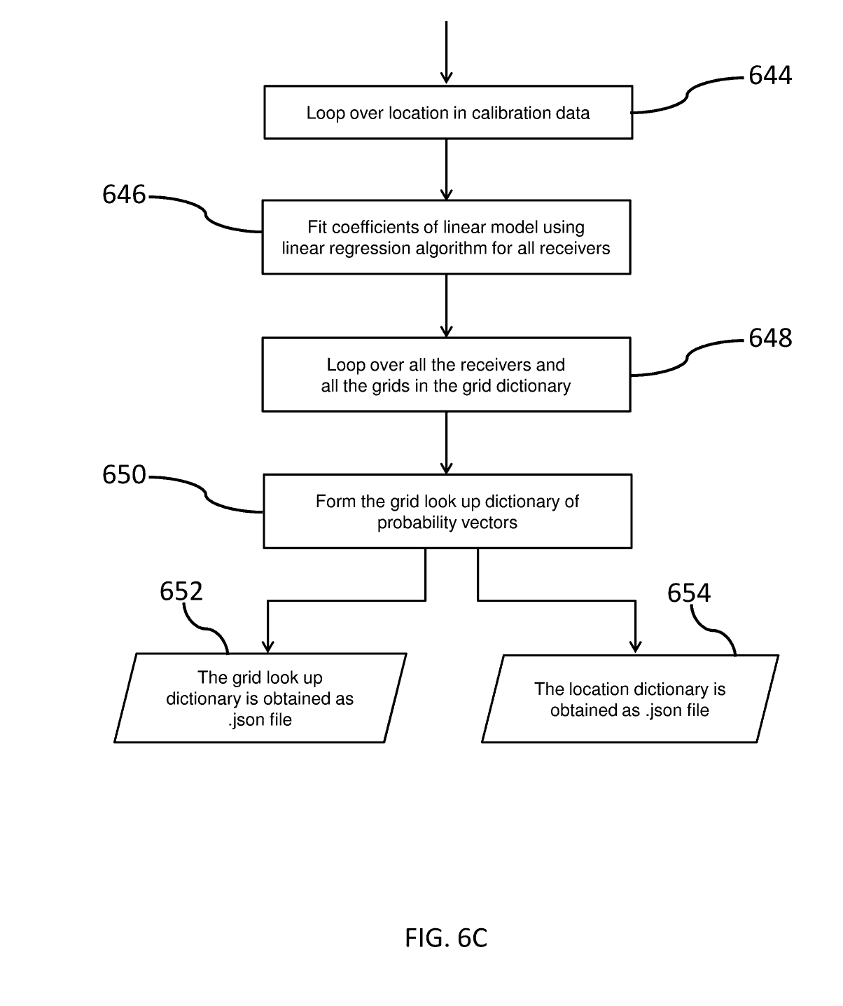

Referring to FIGS. 6A-6C, illustrated are actions of a fourth example process for generating the grid dictionary, the grid look-up dictionary and the location dictionary. At 602, the server 112 receives data associated with the SVG map 202 of the facility 104. In an example, the server 112 is configured to receive .json files (from Andrews script).

At 604, the server 112 determines whether there is more than one level or floor in the facility 104. If there is more than one level, at 606, the server 112 finds Z points (Z coordinates) existing on the first level and a level being considered and performs shifting and scaling, to thereby find an average linear shift and scaling such that the Z points coincide for all of the levels of the facility. At 608, the server 112 loops over all the points on the considered level and further scales the coordinates such that the Z points coincide with the first level. A new dictionary of scaled points is produced. At 610, the server 112 to loops over all the data associated with the SVG map 206 and thereby find lists of receivers, units, zones, entrances and etc. present on the first level of the facility 104. If the server determines at 604 that there is only one level, then looping over all map data and finding the lists at 610 is performed directly by the server 112.

Once the lists of the receivers, units, zones, entrances and the like are determined, then at 612, the server 112 creates a plurality of dictionaries associated with the SVG map 202 of the facility 104 including location (units) dictionary, receiver dictionary, zone dictionary, entrance dictionary and the like. Thereafter, the server 112 populates each of the plurality of dictionaries with the attributes of the facility 104, for example, floor number and coordinates marking location (for receivers and entrances) or ordered list of coordinates marking boundary (for zones and locations) and the like.

At 620, the server 112 forms a zone boundary dictionary by looping over the zone dictionary to thereby add a zone boundary for every consecutive, connected point defining objects of a facility on the SVG map. After the formation of the zone boundary dictionary and the wall dictionary, the server 112 finds the location of the grid square and the grid zone using a subroutine to update the grid dictionary at 630 as mentioned above.

At 632, the server 112 finds, for each receiver in the receiver dictionary, the distance between the grid square and the receiver, the angle between the grid square and the receiver, the number of walls between the grid square and the receiver and then updates each to the grid dictionary. Further, at 634, the server 112 deletes the grid squares exterior to the facility or other perimeter of interest. At 636, the server 112, for each grid square, loops over the entrance dictionary by finding distance to the grid square, determining nearest entrance, updating the entrance to the grid dictionary and forming the list of nearest grids for the each entrance.

At 638, the server 112 finds the minimum number of grid squares running over all entrances of the facility 104. Further, for each entrance and for a number of nearest grid squares, the server 112 updates, to the grid dictionary, data related to each entrance.

At 644, the server 112 loops over location in calibration data, every cluster in the location, every receiver in the cluster, all grid keys/receivers in that location. As such, calibration data is grouped by location and then clustered for each location. As with processes 300, 400 and 500, the server 112 is configured to append power (RSS) of the probe request to the OLS data dictionary and a power error to the OLS data dictionary. Further, the server 112 is configured to look up distance, walls crossed and an angle from the grid square to the receiver, find difference in floors between the grid square and the receiver, append to X-variables (mentioned above with reference to FIG. 2), pass X-variables through choice of ansatz model and finally append to X-variables.

At 646, the server 112, for all the receivers, fits coefficients of a linear model using a linear regression algorithm, use cross validation to estimate standard error, count number of clusters per receivers and update to the OLS model dictionary. Further, if the server 112 finds that the receiver has less than 10 clusters, then the server 112 computes a mean over other receivers, as described above. At 648, the server 112 loops over all the grid squares in the grid dictionary, loop over all the receivers, and look up the X-variables for grid squares (for example, distance, walls, angle, and the like) from the grid dictionary. As such, a normal distribution of the expected RSS measured at each receiver is formed. Further, the server 112 is configured to find variables for the model, look up the model for the receiver and calculate a predicted RSS for the grid square and the receiver.

At 650, the server 112 forms the grid look-up dictionary of probability vectors, over all the grid squares and for every possible power and receiver. At 652 and 654, both the grid look up dictionary and the location dictionary are obtained as .json file respectively.

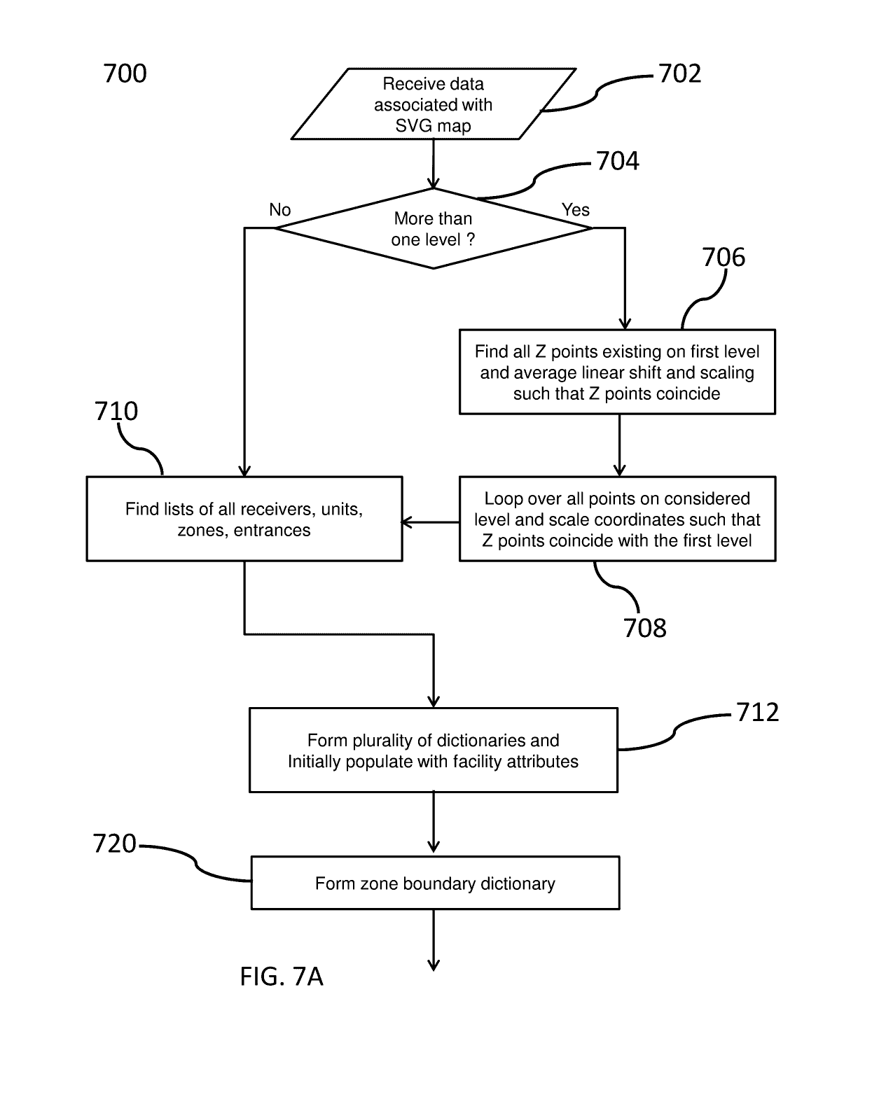

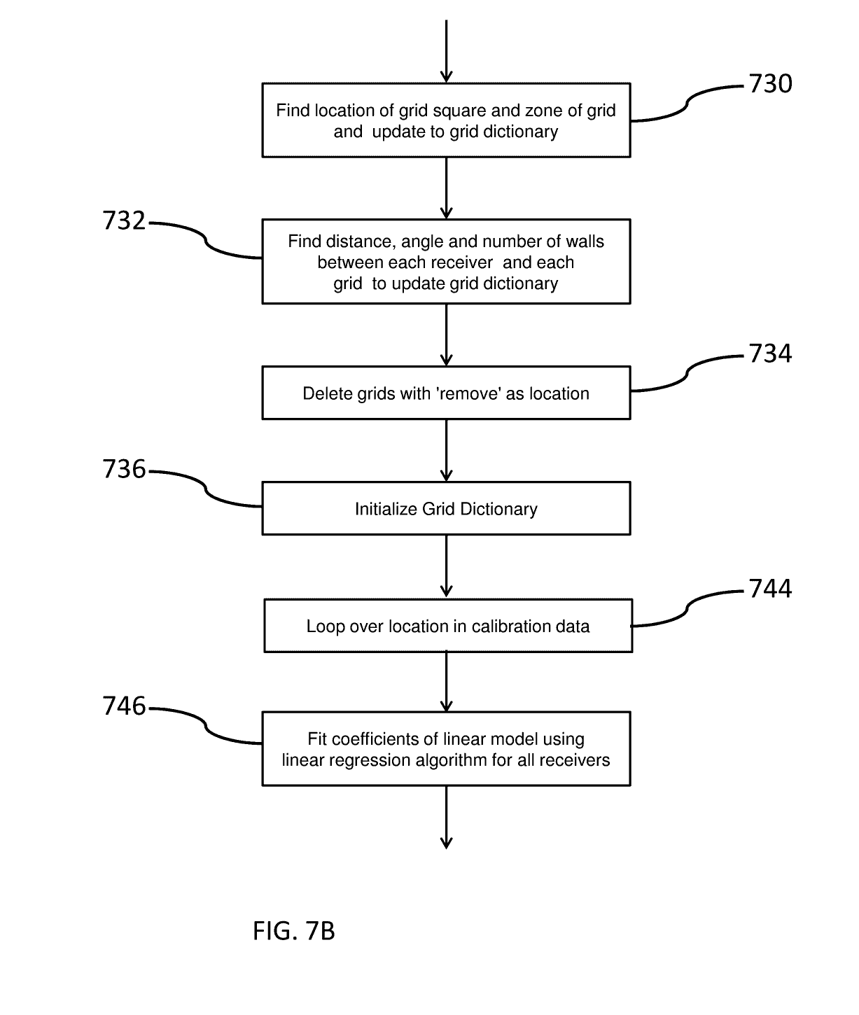

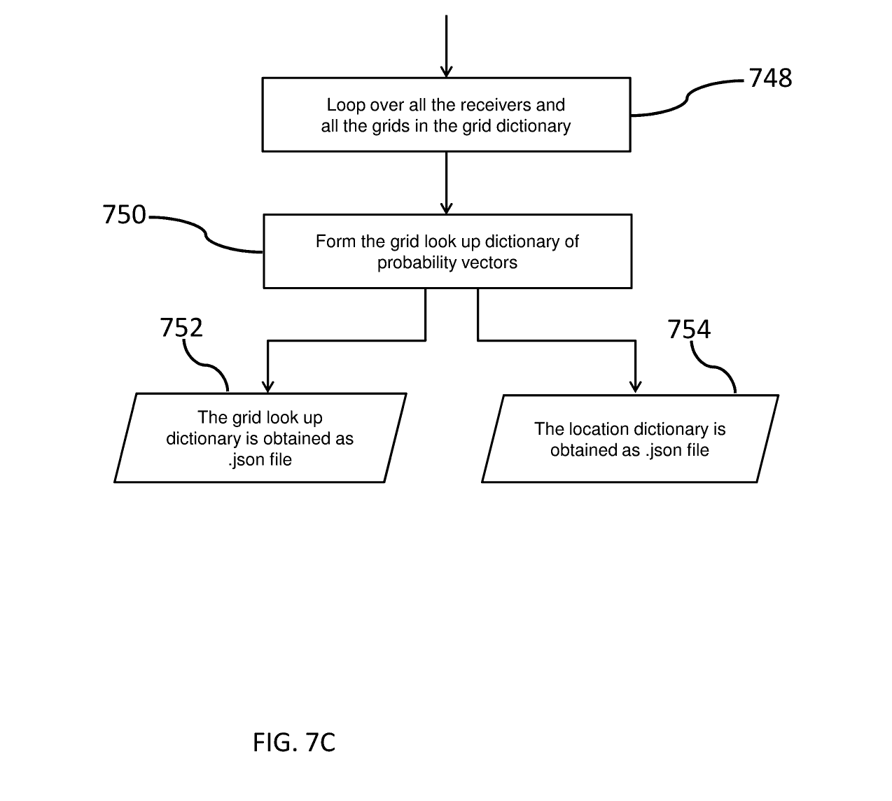

Referring to FIGS. 7A-7C, illustrated are actions of a fifth example process for generating the grid dictionary, the grid look-up dictionary and the location dictionary. At 702, the server 112 receives data associated with the SVG map 202 of the facility 104. As above, the server 112 may be configured to receive .json files (from Andrews script).

At 704, the server 112 checks whether there is more than one level or floor in the facility 104. If there is more than one level, then at 706, the server 112 performs shifting and scaling, to thereby find an average linear shift and scaling such that the Z points coincide for all levels. At 708, the server 112 loops over all the points on the considered level and further scales the coordinates such that the Z points coincide with the first level. A new dictionary of scaled points is produced. At 710, the server 112 loops over all the data associated with the SVG map 206 and thereby find lists of receivers, units, zones, entrances and etc. present on the first level of the facility 104. If the server determines at 704 that there is only one level, then looping over all map data and finding the lists at 710 is performed directly by the server 112.

Once the lists of the receivers, units, zones, entrances and the like are determined, then at 712, the server 112 creates a plurality of dictionaries associated with the SVG map 202 of the facility 104 including location (units) dictionary, receiver dictionary, zone dictionary, entrance dictionary and the like. Thereafter, the server 112 populates each of the plurality of dictionaries with the attributes of the facility 104, for example, floor number and coordinates marking location (for receivers and entrances) or ordered list of coordinates marking boundary (for zones and locations) and the like.

At 720, the server 112 forms a zone boundary dictionary by looping over the zone dictionary to thereby add a zone boundary for every consecutive, connected point defining objects of a facility on the SVG map. After the formation of the zone boundary dictionary and the wall dictionary, the server 112 finds the location of the grid square and the grid zone using a subroutine to update the grid dictionary at 730, as mentioned above.

At 732, the server 112 finds, for each receiver in the receiver dictionary, the distance between the grid square and the receiver, the angle between the grid square and the receiver, the number of walls between the grid square and the receiver and then updates each to the grid dictionary. Further, at 734, the server 112 deletes the grid squares exterior to the perimeter of interest. At 736, the server 112, for each grid square, loops over the entrance dictionary by finding distance to the grid square, determining nearest entrance, updating the entrance to the grid dictionary and forming the list of nearest grid squares for the each entrance.

At 744, the server 112 loops over location in calibration data, to group calibration data by location and then cluster the data for each location. Again, as with processes 300-600, the server 112 is configured to append power (RSS) of the probe request to the OLS data dictionary and a power error to the OLS data dictionary. Further, the server 112 is configured to look up distance, walls crossed and an angle from the grid square to the receiver, find difference in floors between the grid square and the receiver, append to X-variables (mentioned above with reference to FIG. 2), pass X-variables through choice of ansatz model and finally append to X-variables.

At 746, the server 112, for all the receivers, fits coefficients of a linear model using a linear regression algorithm, use cross validation to estimate standard error, count number of clusters per receivers and update to the OLS model dictionary. Further, if the server 112 finds that the receiver has less than 10 clusters, then the server 112 computes a mean over other receivers, as described above. At 748, the server 112 loops over all the grid squares in the grid dictionary, loop over all the receivers, and look up the X-variables for grid square (for example, distance, walls, angle, and the like) from the grid dictionary to form a normal distribution of the expected RSS measured at each receiver. Further, the server 112 is configured to find variables for the model, look up the model for the receiver and calculate a predicted RSS for the grid square and the receiver.

At 750, the server 112 forms the grid look-up dictionary of probability vectors, over all the grid squares and for every possible power and receiver. At 752 and 754, both the grid look up dictionary and the location dictionary are obtained as .json file respectively.

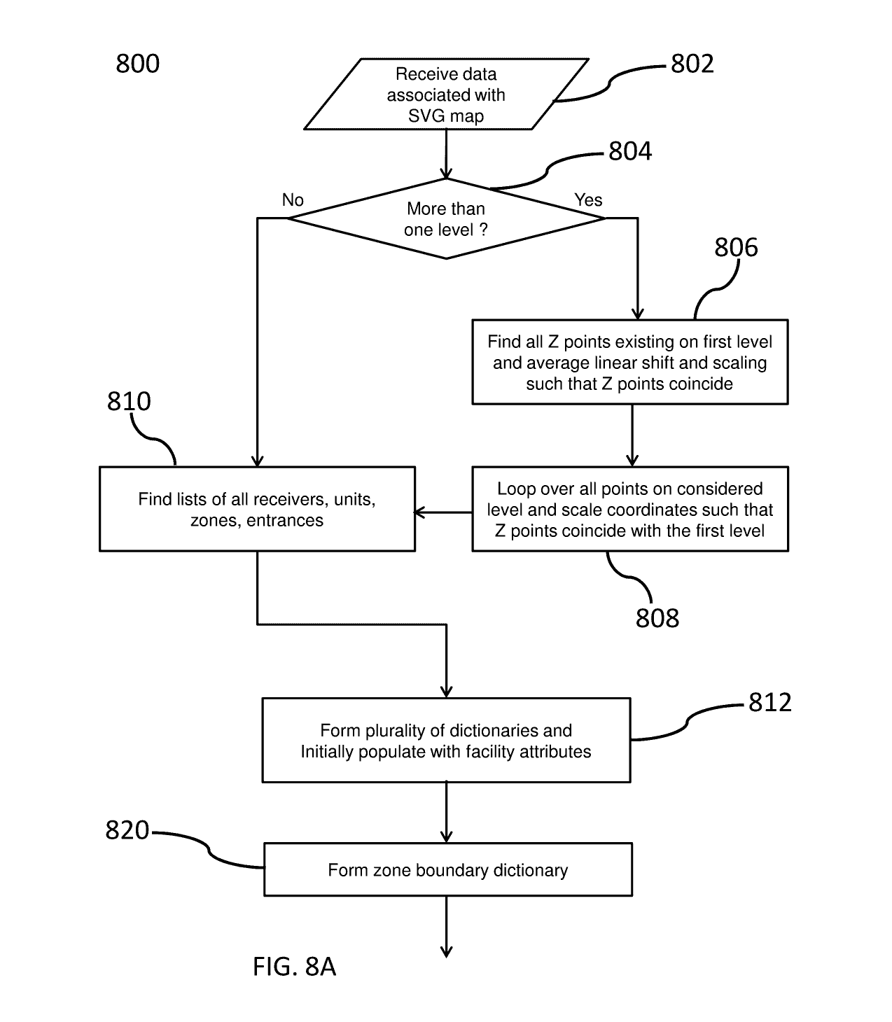

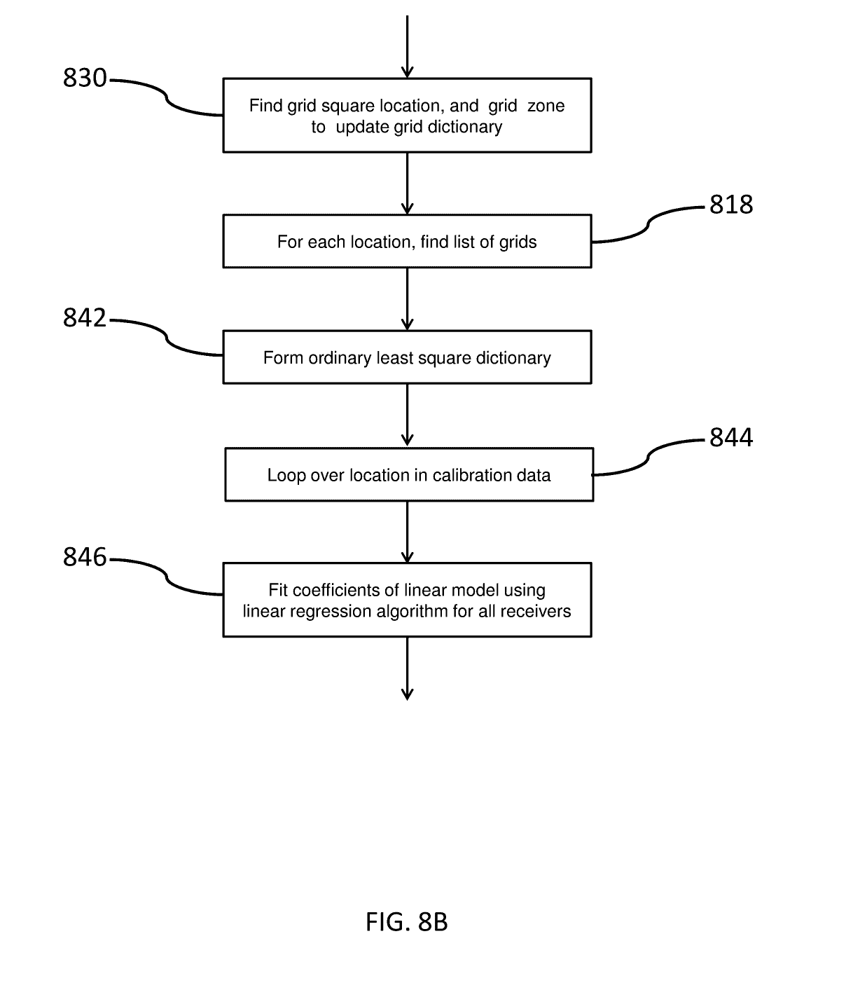

Referring to FIGS. 8A-8C, illustrated are actions of a sixth example process for generating the grid dictionary, the grid look-up dictionary and the location dictionary. At 802, the server 112 receives data associated with the SVG map 202 of the facility 104. As above, the server 112 may be configured to receive .json files from Andrews script).

At 804, the server 112 checks whether there is more than one level or floor in the facility 104. If there is more than one level, then at 806, the server 112 performs shifting and scaling, to thereby find an average linear shift and scaling such that the Z points coincide for all levels. At 808, the server 112 loops over all the points on the considered level and further scales the coordinates such that the Z points coincide with the first level. A new dictionary of scaled points is produced. At 810, the server 112 loops over all the data associated with the SVG map 206 and thereby find lists of receivers, units, zones, entrances and etc. present on the first level of the facility 104. If the server determines at 804 that there is only one level, then looping over all map data and finding the lists at 810 is performed directly by the server 112.

Once the lists of the receivers, units, zones, entrances and the like are determined, then at 812, the server 112 creates a plurality of dictionaries associated with the SVG map 202 of the facility 104 including location (units) dictionary, receiver dictionary, zone dictionary, entrance dictionary and the like. Thereafter, the server 112 populates each of the plurality of dictionaries with the attributes of the facility 104, for example, floor number and coordinates marking location (for receivers and entrances) or ordered list of coordinates marking boundary (for zones and locations) and the like.

At 820, the server 112 forms a zone boundary dictionary by looping over the zone dictionary to thereby add a zone boundary for every consecutive point. After the formation of the zone boundary dictionary and the wall dictionary, the server 112 finds the location of the grid square and the grid zone using a subroutine to update the grid dictionary at 830 as mentioned above.

At 818, the server 112, for each location (unit), loops over the grid dictionary in order to find a list of grid squares in each unit. Further, the server 112 produces data points fit to produce a model for RSS.

As explained above, the server 112 is configured to produce data points that are fit to produce the model for the RSS. Thus, at 842, the server 112 forms an ordinary least square dictionary (OLS data dictionary) which contains data for linear regression. At 844, the server 112 loops over location in calibration data, every cluster in the location, every receiver in the cluster, all grid keys/receivers in that location to group calibration data by location and then cluster the data for each location. As with processes 300-700, the server 112 is configured to append power (RSS) of the probe request to the OLS data dictionary and a power error to the OLS data dictionary. Further, the server 112 is configured to look up distance, walls crossed and an angle from the grid square to the receiver, find difference in floors between the grid square and the receiver, append to X-variables (mentioned above with reference to FIG. 2), pass X-variables through choice of ansatz model and finally append to X-variables.

At 846, the server 112, for all the receivers, fits coefficients of a linear model using a linear regression algorithm, use cross validation to estimate standard error, count number of clusters per receivers and update to the OLS model dictionary. Further, if the server 112 finds that the receiver has less than 10 clusters, then the server 112 computes a mean over other receivers, as described above. At 848, the server 112 loops over all the grid squares in the grid dictionary, loop over all the receivers, and look up the X-variables for grid squares (for example, distance, walls, angle, and the like) from the grid dictionary to form a normal distribution of the expected RSS values measured at each receiver. Further, the server 112 is configured to find variables for the model, look up the model for the receiver and calculate a predicted RSS for the grid square and the receiver.

At 850, the server 112 forms the grid look-up dictionary of probability vectors, over all the grid squares and for every possible power and receiver. At 852 and 854, both the grid look up dictionary and the location dictionary are obtained as .json file respectively.

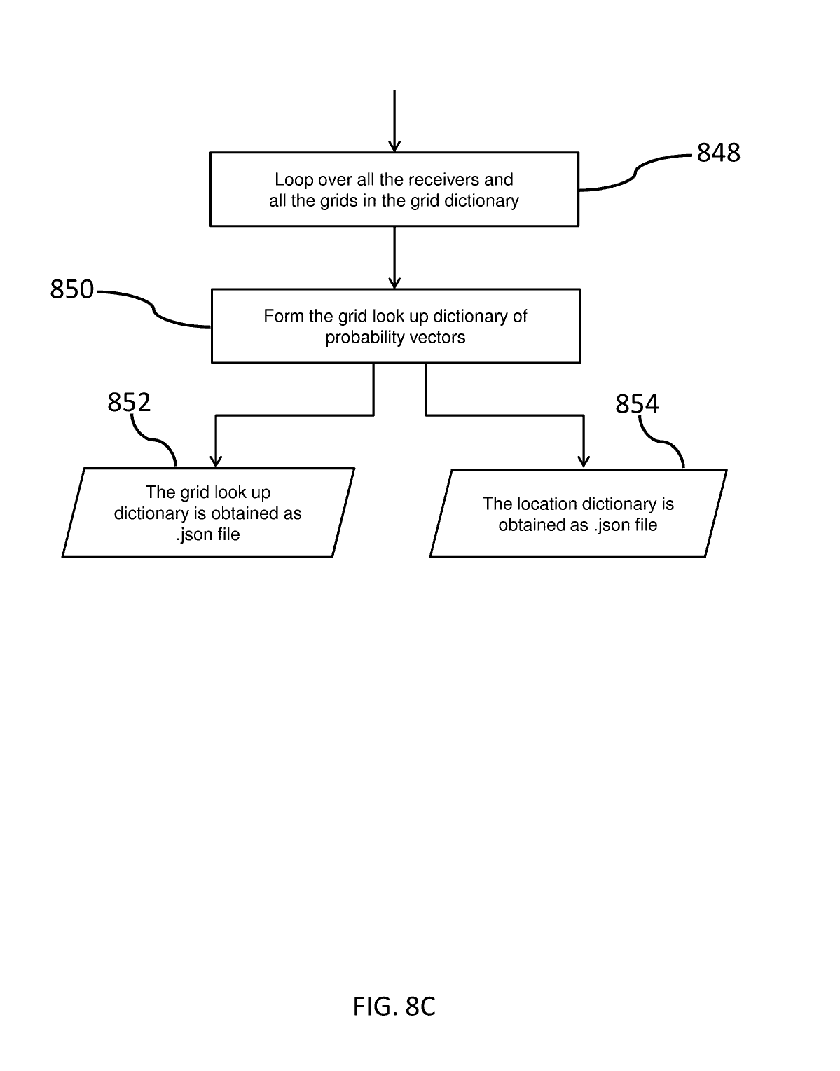

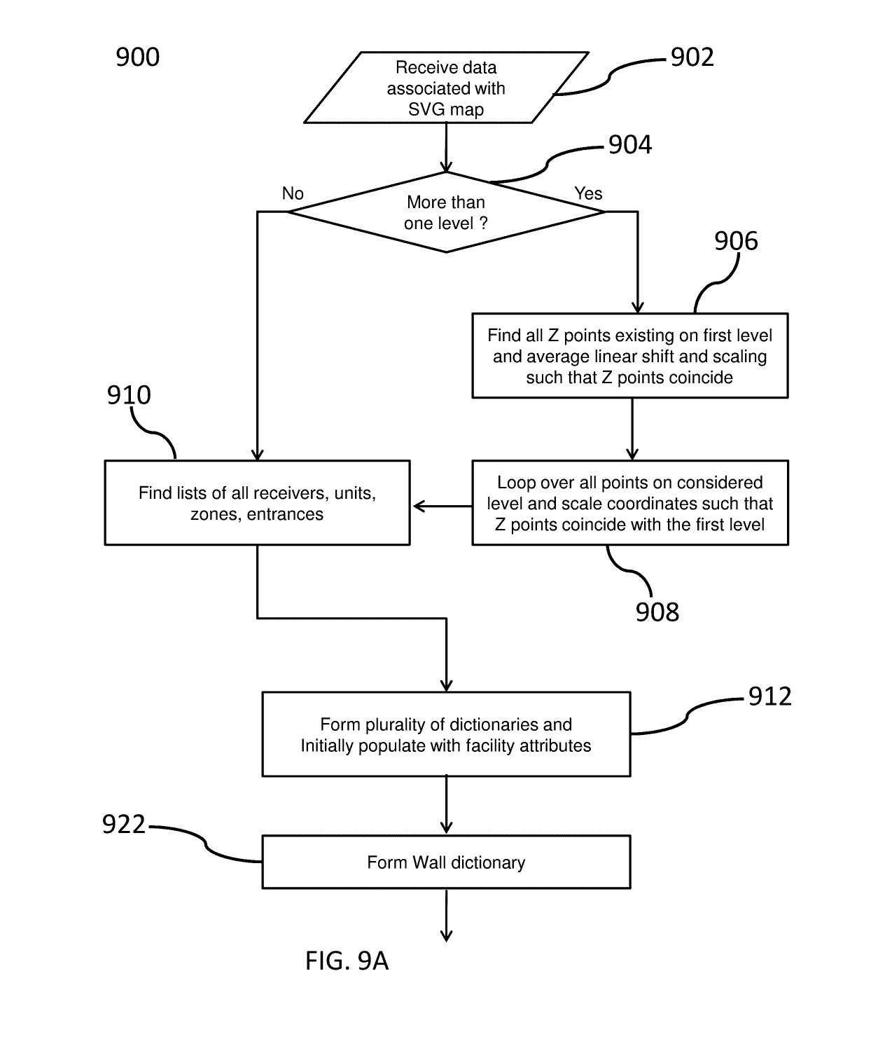

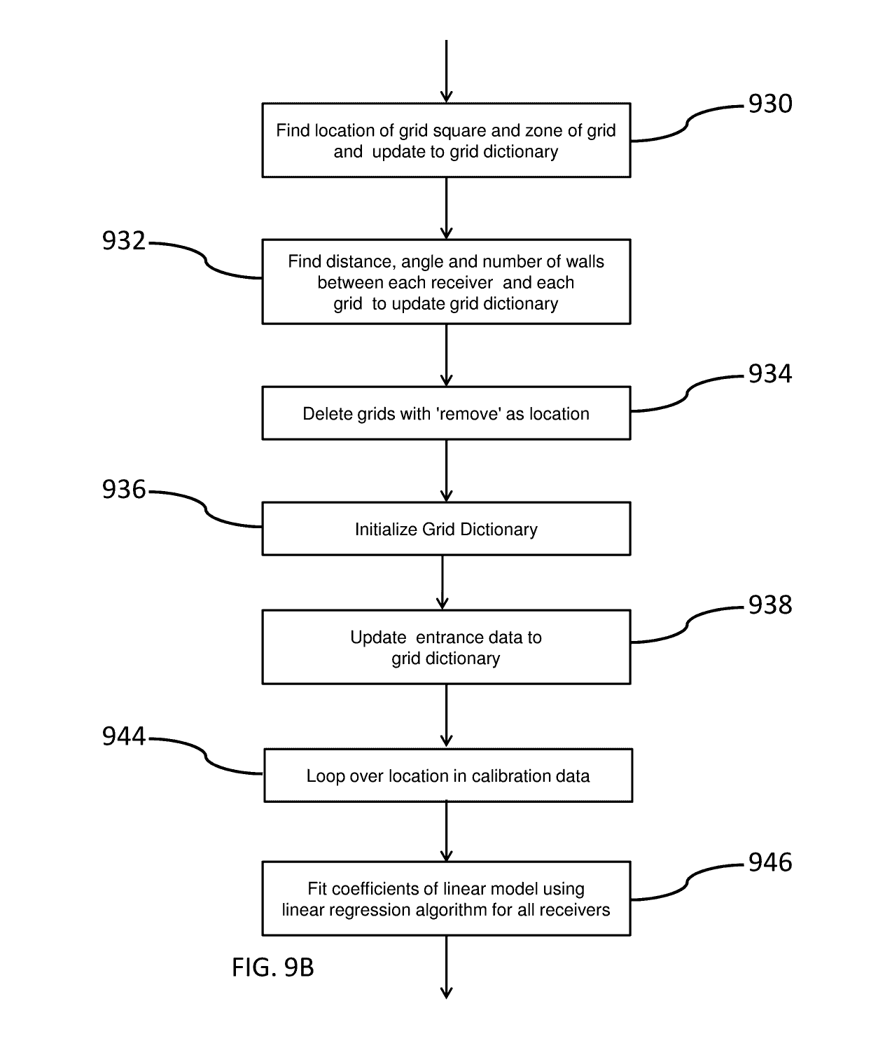

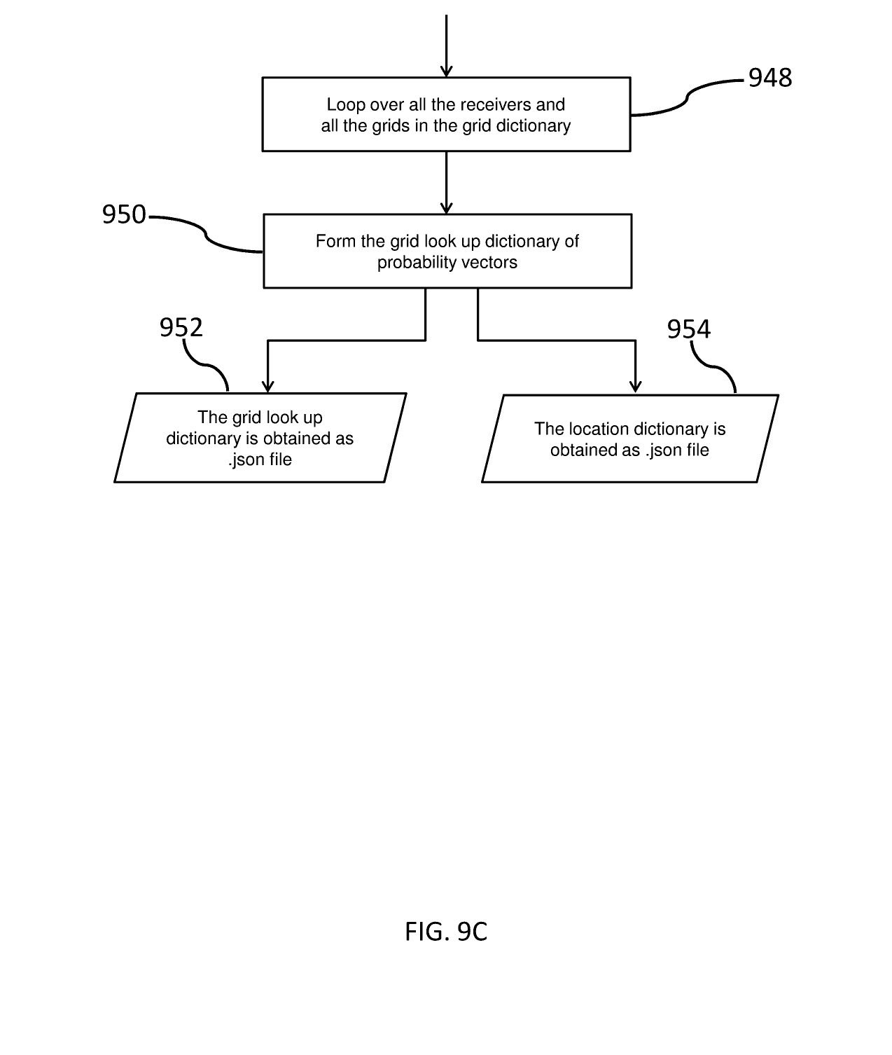

Referring to FIGS. 9A-9C, illustrated are actions of a seventh example process for generating the grid dictionary, the grid look-up dictionary and the location dictionary. At 902, the server 112 receives data associated with the SVG map 202 of the facility 104. As above, the server 112 may be configured to receive .json files from (Andrews script).

At 904, the server 112 checks whether there is more than one level or floor in the facility 104. If there is more than one level, then at 906, the server 112 performs shifting and scaling, to find an average linear shift and scaling such that the Z points coincide for all levels. At 908, the server 112 loops over all the points on the considered level and further scales the coordinates such that the Z points coincide with the first level. A new dictionary of scaled points is produced. At 910, the server 112 loops over all the data associated with the SVG map 206 and thereby find lists of receivers, units, zones, entrances and etc. present on the first level of the facility 104. If the server determines at 904 that there is only one level, then looping over all map data and finding the lists at 910 is performed directly by the server 112.

Once the lists of the receivers, units, zones, entrances and the like are determined, then at 912, the server 112 creates a plurality of dictionaries associated with the SVG map 202 of the facility 104 including location (units) dictionary, receiver dictionary, zone dictionary, entrance dictionary and the like. Thereafter, the server 112 populates each of the plurality of dictionaries with the attributes of the facility 104, for example, floor number and coordinates marking location (for receivers and entrances) or ordered list of coordinates marking boundary (for zones and locations) and the like.

At 922, the server 112 forms the wall dictionary, for example by looping over the locations dictionary and adding a wall for every two consecutive points described in detail with reference to FIGS. 14A & 14B below. Further, each entry consists of two co-ordinates and a location key representing and identifying the location. In an example, key L01U034 identifies unit 34 of level 1. After the formation of the zone boundary dictionary and the wall dictionary, the server 112 finds the location of the grid square and the grid zone using a subroutine to update the grid dictionary at 930 as mentioned above.

At 932, the server 112 finds, for each receiver in the receiver dictionary, the distance between the grid square and the receiver, the angle between the grid square and the receiver, the number of walls between the grid square and the receiver and then updates each to the grid dictionary. Further, at 934, the server 112 deletes the grid squares exterior to the perimeter of interest. At 936, the server 112, for each grid square, loops over the entrance dictionary by finding distance to the grid square, determining nearest entrance, updating the entrance to the grid dictionary and forming the list of nearest grid squares for the each entrance.

At 936, the server 112 finds the minimum number of grid squares running over all entrances of the facility 104. Further, for each entrance and for a number of nearest grid squares, the server 112 updates, to the grid dictionary, data related to each entrance.

At 944, the server 112 loops over location in calibration data, to group calibration data by location and cluster the data for each location. As with processes 300-800, the server 112 is configured to append power (RSS) of the probe request to the OLS data dictionary and a power error to the OLS data dictionary. Further, the server 112 is configured to look up distance, walls crossed and an angle from the grid square to the receiver, find difference in floors between the grid square and the receiver, append to X-variables (mentioned above with reference to FIG. 2), pass X-variables through choice of ansatz model and finally append to X-variables.

At 946, the server 112, for all the receivers, fits coefficients of a linear model using a linear regression algorithm, use cross validation to estimate standard error, count number of clusters per receivers and update to the OLS model dictionary. Further, if the server 112 finds that the receiver has less than 10 clusters, then the server 112 computes a mean over other receivers, as described above. At 948, the server 112 loops over all the grid squares in the grid dictionary, loop over all the receivers, and look up the X-variables for grid squares (for example, distance, walls, angle, and the like) from the grid dictionary to form a normal distribution as mentioned above. Further, the server 112 is configured to find variables for the model, look up the model for the receiver and calculate a predicted RSS for the grid square and the receiver.

At 950, the server 112 forms the grid look-up dictionary of probability vectors, over all the grid squares and for every possible power and receiver. At 952 and 954, both the grid look up dictionary and the location dictionary are obtained as .json file respectively.

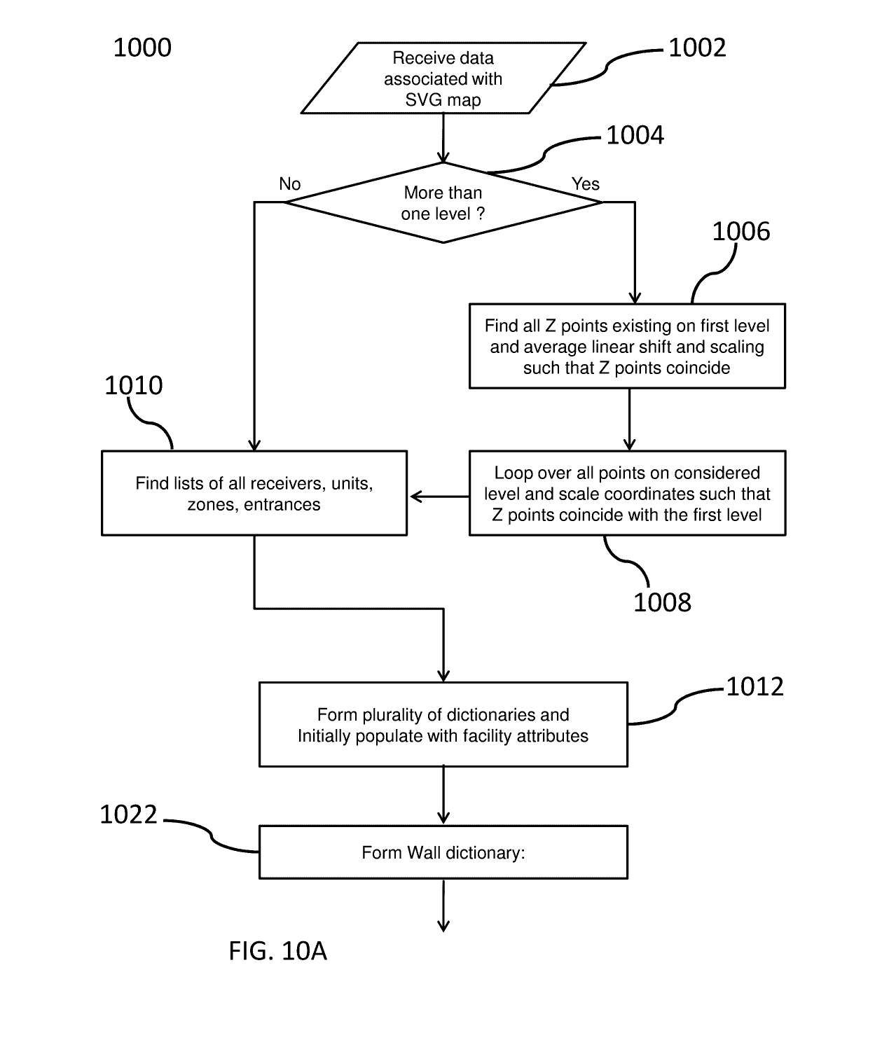

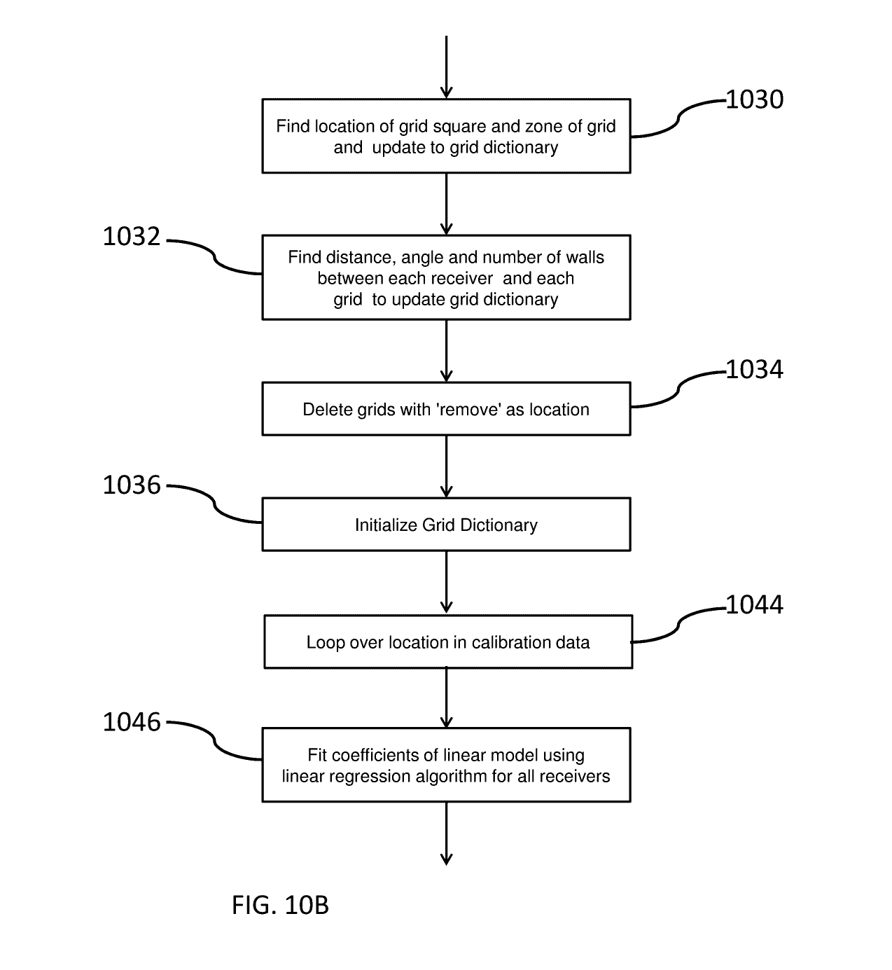

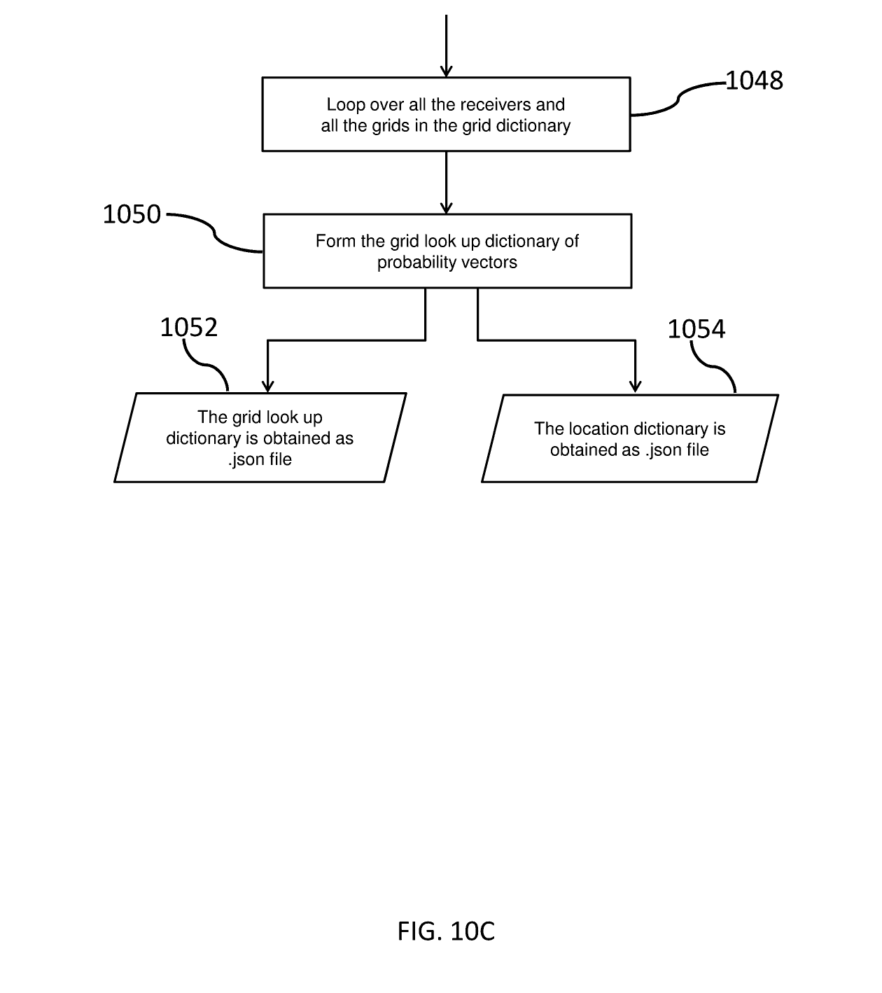

Referring to FIGS. 10A-10C, illustrated are actions of an eighth example process for generating the grid dictionary, the grid look-up dictionary and the location dictionary. At 1002, the server 112 receives data associated with the SVG map 202 of the facility 104. As above, the server 112 may be configured to receive .json files (from Andrews script).

At 1004, the server 112 checks whether there is more than one level or floor in the facility 104. If there is more than one level, then at 1006, the server 112 finds Z points (Z coordinates) and performs shifting and scaling, to thereby find an average linear shift and scaling such that the Z points coincide for all levels. At 1008, the server 112 loops over all the points on the considered level and further scales the coordinates such that the Z points coincide with the first level. A new dictionary of scaled points is produced. At 1010, the server 112 loops over all the data associated with the SVG map 206 and thereby find lists of receivers, units, zones, entrances and etc. present on the first level of the facility 104. If the server determines at 1004 that there is only one level, then looping over all map data and finding the lists at 1010 is performed directly by the server 112.

Once the lists of the receivers, units, zones, entrances and the like are determined, then at 1012, the server 112 creates a plurality of dictionaries associated with the SVG map 202 of the facility 104 including location (units) dictionary, receiver dictionary, zone dictionary, entrance dictionary and the like. Thereafter, the server 112 populates each of the plurality of dictionaries with the attributes of the facility 104, for example, floor number and coordinates marking location (for receivers and entrances) or ordered list of coordinates marking boundary (for zones and locations) and the like.

At 1022, the server 112 forms the wall dictionary, for example by looping over the locations dictionary and adding a wall for every two consecutive points. Further, each entry consists of two co-ordinates and a location key. After the formation of the zone boundary dictionary and the wall dictionary, the server 112 finds the location of the grid square and the grid zone using a subroutine to update the grid dictionary at 330, as mentioned above.

At 1032, the server 112 finds, for each receiver in the receiver dictionary, the distance between the grid square and the receiver, the angle between the grid square and the receiver, the number of walls between the grid square and the receiver and then updates each to the grid dictionary. Further, at 1034, the server 112 deletes the grid squares exterior to a perimeter of interest. At 1036, the server 112, for each grid square, loops over the entrance dictionary by finding distance to the grid square, determining nearest entrance, updating the entrance to the grid dictionary and forming the list of nearest grid squares for the each entrance.

At 1044, the server 112 groups calibration data by location and clusters the data for each location. As with processes 300-900, the server 112 is configured to append power (RSS) of the probe request to the OLS data dictionary and a power error to the OLS data dictionary. Further, the server 112 is configured to look up distance, walls crossed and an angle from the grid square to the receiver, find difference in floors between the grid square and the receiver, append to X-variables (mentioned above with reference to FIG. 2), pass X-variables through choice of ansatz model and finally append to X-variables.

At 1046, the server 112, for all the receivers, fits coefficients of a linear model using a linear regression algorithm, use cross validation to find estimate standard error, count number of clusters per receivers and update to the OLS model dictionary. Further, if the server 112 finds that the receiver has less than 10 clusters, then the server 112 computes a mean over other receivers, as described above. At 1048, the server 112 forms the normal distribution of expected RSS values for each receiver as described above. Further, the server 112 is configured to find variables for the model, look up the model for the receiver and calculate a predicted RSS for the grid square and the receiver.

At 1050, the server 112 forms the grid look-up dictionary of probability vectors, over all the grid squares and for every possible power and receiver. At 1052 and 1054, both the grid look up dictionary and the location dictionary are obtained as .json file respectively.

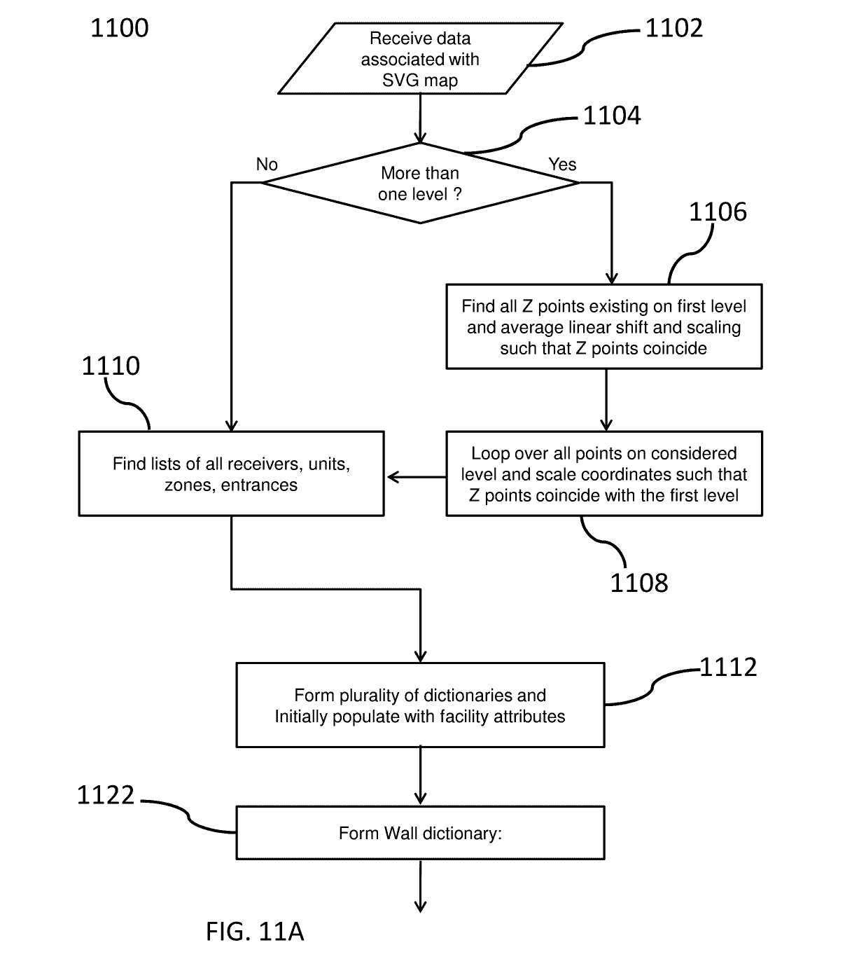

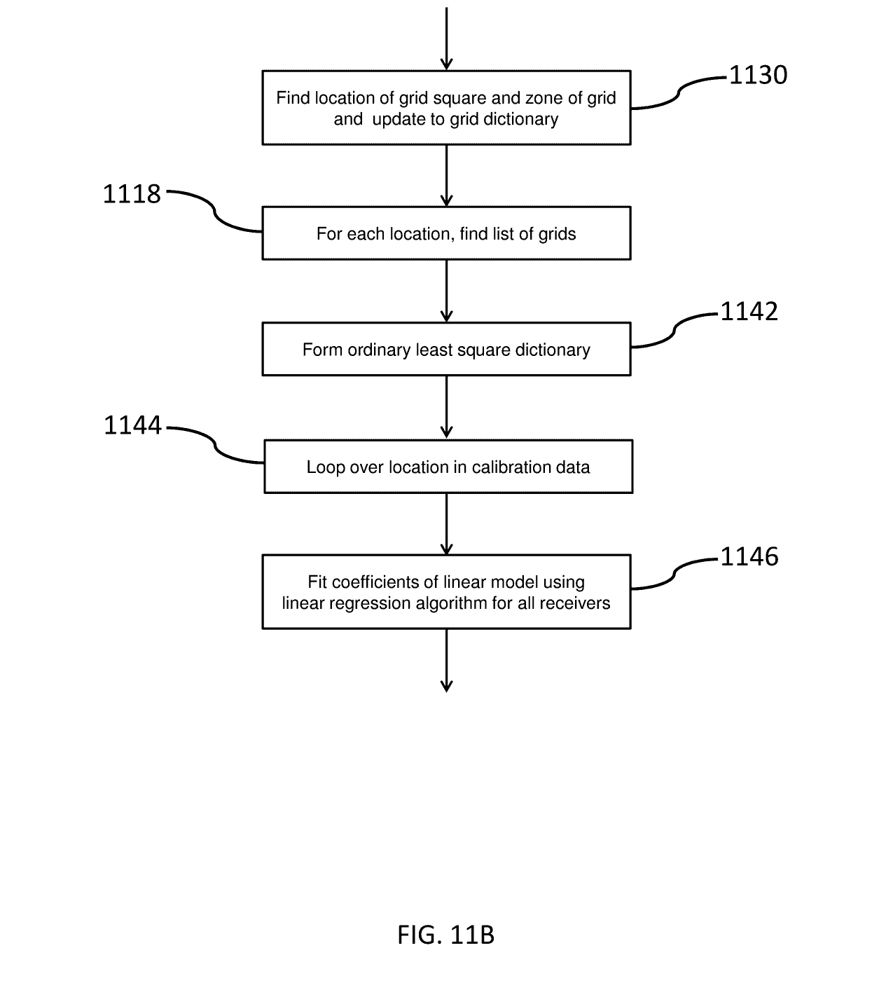

Referring to FIGS. 11A-11C, illustrated are actions of a ninth example process for generating the grid dictionary, the grid look-up dictionary and the location dictionary. At 1102, the server 112 receives data associated with the SVG map 202 of the facility 104. As above, the server 112 may be configured to receive .json files (from Andrews script).

At 1104, the server 112 checks whether there is more than one level or floor in the facility 104. If there is more than one level, then at 1106, the server 112 finds Z points such that the Z points coincide for every level. At 1108, the server 112 loops over all the points on the considered level and further scales the coordinates such that the Z points coincide with the first level. A new dictionary of scaled points is produced. At 1110, the server 112 loops over all the data associated with the SVG map 206 and thereby find lists of receivers, units, zones, entrances and etc. present on the first level of the facility 104. If the server determines at 1104 that there is only one level, then looping over all map data and finding the lists at 1110 is performed directly by the server 112.

Once the lists of the receivers, units, zones, entrances and the like are determined, then at 1112, the server 112 creates a plurality of dictionaries associated with the SVG map 202 of the facility 104 including location (units) dictionary, receiver dictionary, zone dictionary, entrance dictionary and the like. Thereafter, the server 112 populates each of the plurality of dictionaries with the attributes of the facility 104, for example, floor number and coordinates marking location (for receivers and entrances) or ordered list of coordinates marking boundary (for zones and locations) and the like.

At 1122, the server 112 forms the wall dictionary, for example by looping over the locations dictionary and adding a wall for every two consecutive points. Further, each entry consists of two co-ordinates and a location key. After the formation of the zone boundary dictionary and the wall dictionary, the server 112 finds the location of the grid square and the grid zone using a subroutine to update the grid dictionary at 330, as mentioned above.

At 1118, the server 112, for each location (unit), loops over the grid dictionary in order to find a list of grid squares in each unit. Further, the server 112 produces data points fit to produce a model for RSS.

As explained above, the server 112 is configured to produce data points that are fit to produce the model for the RSS. Thus, at 1142, the server 112 forms an ordinary least square dictionary (OLS data dictionary) which contains data for linear regression. At 1144, the server 112 groups calibration data by location and then clusters the data for each location. As with processes 300-1000, the server 112 is configured to append power (RSS) of the probe request to the OLS data dictionary and a power error to the OLS data dictionary. Further, the server 112 is configured to look up distance, walls crossed and an angle from the grid square to the receiver, find difference in floors between the grid square and the receiver, append to X-variables (mentioned above with reference to FIG. 2), pass X-variables through choice of ansatz model and finally append to X-variables.

At 1146, the server 112, for all the receivers, fits coefficients of a linear model using a linear regression algorithm, use cross validation to find estimate standard error, count number of clusters per receivers and update to the OLS model dictionary. Further, if the server 112 finds that the receiver has less than 10 clusters, then the server 112 computes a mean over other receivers, as described above. At 1148, the server 112 forms a normal distribution for the expected RSS values measured at each receiver. Further, the server 112 is configured to find variables for the model, look up the model for the receiver and calculate a predicted RSS for the grid square and the receiver.

At 1150, the server 112 forms the grid look-up dictionary of probability vectors, over all the grid squares and for every possible power and receiver. At 1152 and 1154, both the grid look up dictionary and the location dictionary are obtained as .json file respectively.

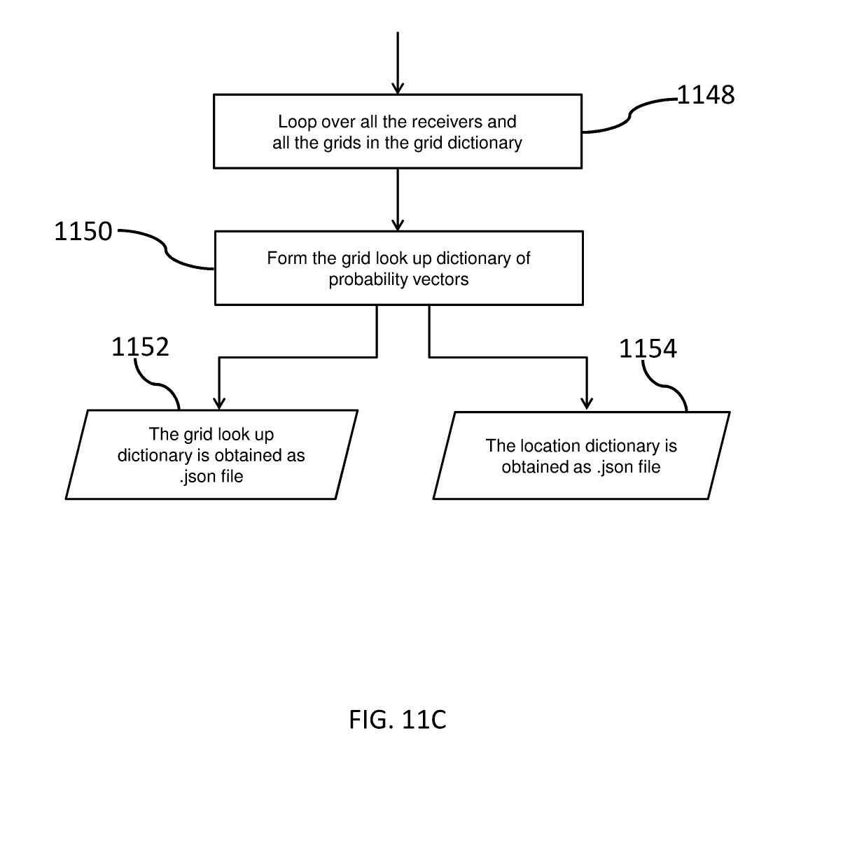

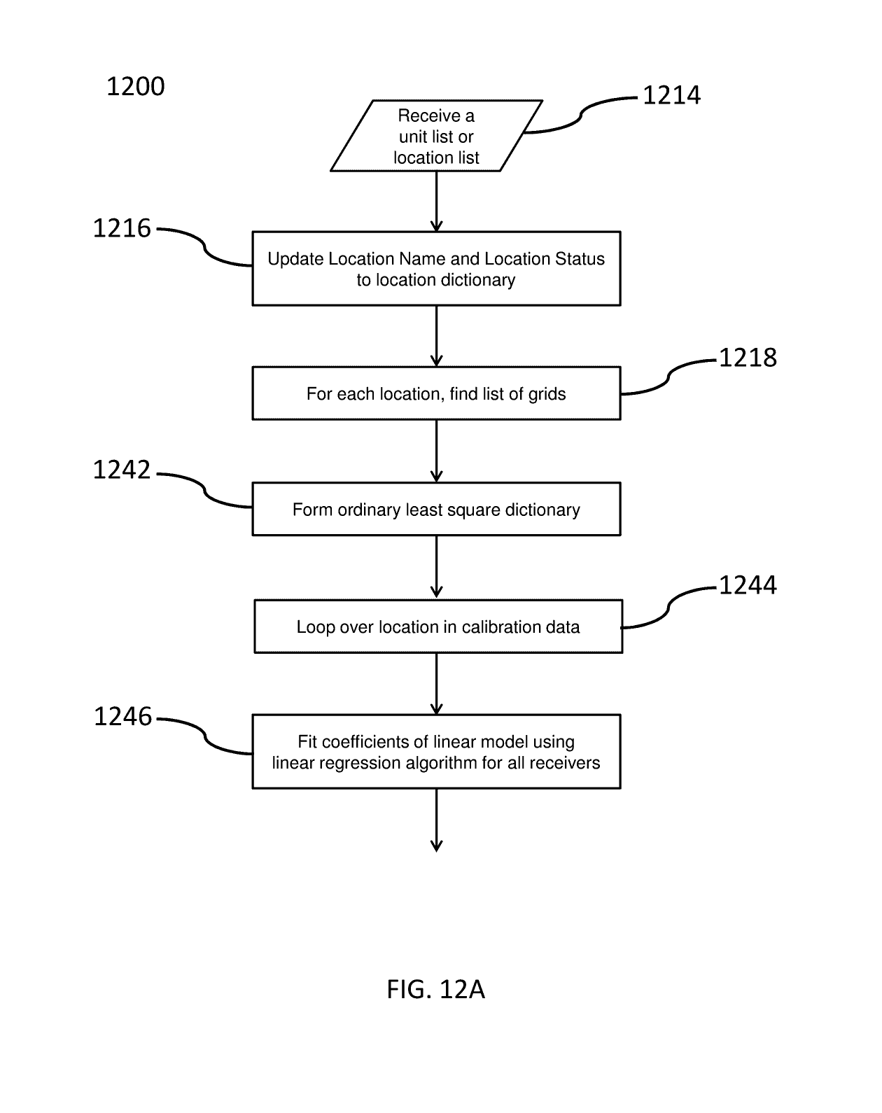

Referring to FIGS. 12A-12B, illustrated are actions of a tenth example process for generating the grid dictionary, the grid look-up dictionary and the location dictionary. At 1214, the server 112 receives a unit list or a location list from the SVG map 202. At 1216, the unit name and the unit status are updated from the unit list to the location dictionary. At 1618, the server 112, for each location (unit), loops over the grid dictionary in order to find a list of grid squares in each unit. Further, the server 112 produces data points fit to produce a model for RSS.

As explained above, the server 112 is configured to produce data points that are fit to produce the model for the RSS. Thus, at 1242, the server 112 forms an ordinary least square dictionary (OLS data dictionary) which contains data for linear regression. At 1244, the server 112 groups calibration data by location and clusters the data for each location. As with processes 300-1100, the server 112 is configured to append power (RSS) of the probe request to the OLS data dictionary and a power error to the OLS data dictionary. Further, the server 112 is configured to look up distance, walls crossed and an angle from the grid square to the receiver, find difference in floors between the grid square and the receiver, append to X-variables (mentioned above with reference to FIG. 2), pass X-variables through choice of ansatz model and finally append to X-variables.

At 1246, the server 112, for all the receivers, fits coefficients of a linear model using a linear regression algorithm, use cross validation to estimate standard error, count number of clusters per receivers and update to the OLS model dictionary. Further, if the server 112 finds that the receiver has less than 10 clusters, then the server 112 computes a mean over other receivers. At 1248, the server 112 forms the RSS normal distribution as described above. Further, the server 112 is configured to find variables for the model, look up the model for the receiver and calculate a predicted RSS for the grid square and the receiver.

At 1250, the server 112 forms the grid look-up dictionary of probability vectors, over all the grid squares and for every possible power and receiver. At 1252 and 1254, both the grid look up dictionary and the location dictionary are obtained as .json file respectively.

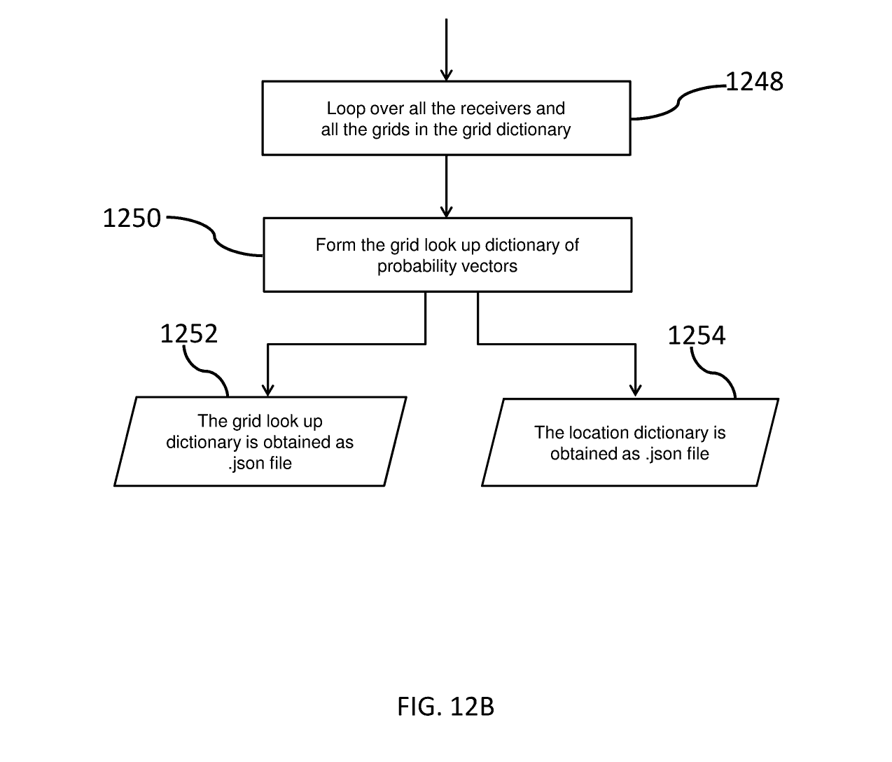

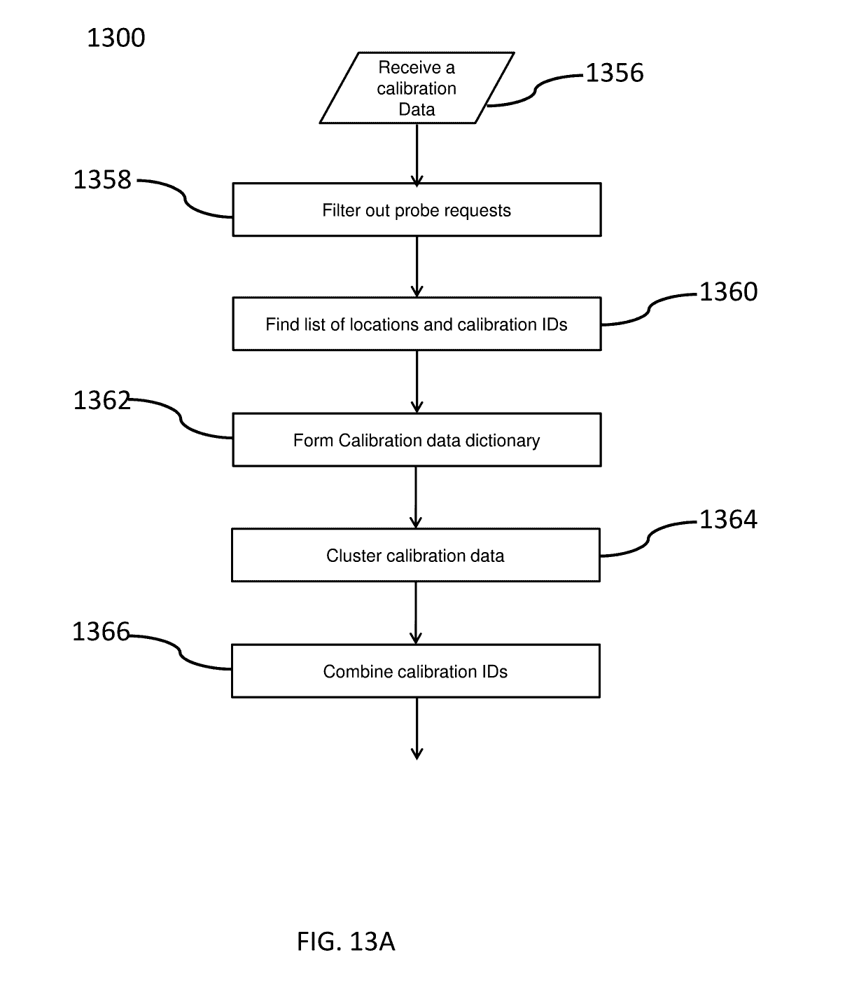

Referring to FIGS. 13A-13B, illustrated are actions of an eleventh example process for generating the grid dictionary, the grid look-up dictionary and the location dictionary. At 1356, the server 112 receives the calibration data. At 1358, the server 112 filters out the probe requests, for example, probes with power greater than −49 and probes not present in the receiver dictionary such as those on the receivers. Further, at 1360, the server 112 loops over the calibration data, to find a list of calibration IDs and a list of locations.

At 1362, the server 112 forms a calibration data dictionary for the each ID in calibration IDs and for the each location in calibration data. Further, the server 112 updates a list of time at which the probes were received and further updates probes in raw data form. At 1364, the server 112 clusters the calibration data and resulting in the formation of the calibration data dictionary. At 1366, the server 112 combines all the calibration IDs into a single entry.

As explained above, the server 112 is configured to produce data points that are fit to produce the model for the RSS. Thus, at 1342, the server 112 forms an ordinary least square dictionary (OLS data dictionary) which contains data for linear regression 1. At 1344, the server 112 groups calibration data by location and then clusters the data for each location. Further, the server 112 is configured to append power (RSS) of the probe request to the OLS data dictionary and a power error to the OLS data dictionary. Further, the server 112 is configured to look up distance, walls crossed and an angle from the grid square to the receiver, find difference in floors between the grid square and the receiver, append to X-variables (mentioned above with reference to FIG. 2), pass X-variables through choice of ansatz model and finally append to X-variables.

At 1346, the server 112, for all the receivers, fits coefficients of a linear model using a linear regression algorithm, use cross validation to estimate standard error, count number of clusters per receivers and update to the OLS model dictionary. Further, if the server 112 finds that the receiver has less than 10 clusters, then the server 112 computes a mean over other receivers, as described above. At 1348, the server 112 forms the RSS normal distribution. Further, the server 112 is configured to find variables for the model, look up the model for the receiver and calculate a predicted RSS for the grid square and the receiver.

At 1350, the server 112 forms the grid square look-up dictionary of probability vectors, over all the grid squares and for every possible power and receiver. At 1352 and 1354, both the grid look up dictionary and the location dictionary are obtained as .json file respectively.

Referring to FIG. 14A and FIG. 14B, illustrated are example actions of a process 1400 for finding the location of the grid square within the facility 104, in accordance with an embodiment of the present disclosure. Those skilled in the art would recognize that the process 1400 illustrates actions involved in the operation of a system such as system 200.

At 1402, the server 112 receives a grid dictionary, and either wall dictionary or zone boundary dictionary each previously formed, for example in accordance with example process 300. Further, at 1406, in order to determine which location a grid square belongs to the server 112 loops over all the grid squares by first setting eight positions to default values, for example, by setting unknown for zones or setting outside for locations and then setting the corresponding eight positions to large values. The eight positions represent directions including North, North1, South, South1, East, East1, West and West1. The nearest two walls are found among four cardinal directions, the location to which the wall belongs is identified and if walls to all directions belong to the same location, it is established that the grid square is inside/within the location. This process overcomes SVG map inaccuracies causing two locations to overlap slightly on the SVG map.

At 1408, the server 112 finds an intersection point between a grid square centre, points at boundary of the SVG map 202, and any one of the eight positions or two wall points. At 1410, the server 112 measures both the distance between the two wall points and the distance between the intersection point and the two wall points. At 1412, the server 112 determines whether the distance between the two wall points equals the sum of two other distances. For example, the server 112 determines whether the intersection point lies on the wall. If the intersection point does not lie on the wall, then another intersection point is found at 1408. However, if the intersection point lies on the wall, then at 1414, the server 112 determines whether the distance between the grid square centre and the intersection point is smaller than the corresponding north, south, east, or west distance or smaller than corresponding the north1, south1, east1 west1 distance. If this is not true, then another intersection point is found at 1408. However, if the distance between the grid square centre and the intersection point is smaller than the corresponding north, south, east, or west distance or smaller than corresponding the north1, south1, east1 west1 distance, then at 1416, the distance between the grid square and the intersection point is determined as a corresponding north, south, east or west distance.

In an example, the distance between the grid square centre and the intersection point is larger than the north, or north1 distance and another intersection point is found according to action 408. In an alternative example, the distance between the grid square centre and the intersection point is smaller than the north or north1 distance, then at 1416, the distance between the grid square and the intersection point is determined as a north.

At 1418a, t server 112 determines whether either of North Position or North Position1 is equal to West or West 1 and South or South 1 and East or East 1. If yes, Grid Position is defined at 1420 as North Position or North1 Position. If no, server 112 also determines at 1418b whether two perpendicular positions are outside of the facility. If yes, Grid Position is defined as ‘Remove’ at 1422. Otherwise, process 1400 returns to find another intersection point at 1408. Example code for causing server 112 to perform these actions includes:

If North Pos= (West or West1) and (South or South1) and (East or East1)
or North1 Pos= (West and West1) and ...
Grid position = North Pos or North1 Pos
Else (just for walls) if two perpendicular positions still ‘outside’
(i.e. no walls to e.g. North and East)
Grid position = ‘Remove’

At 1424, the grid position is obtained.

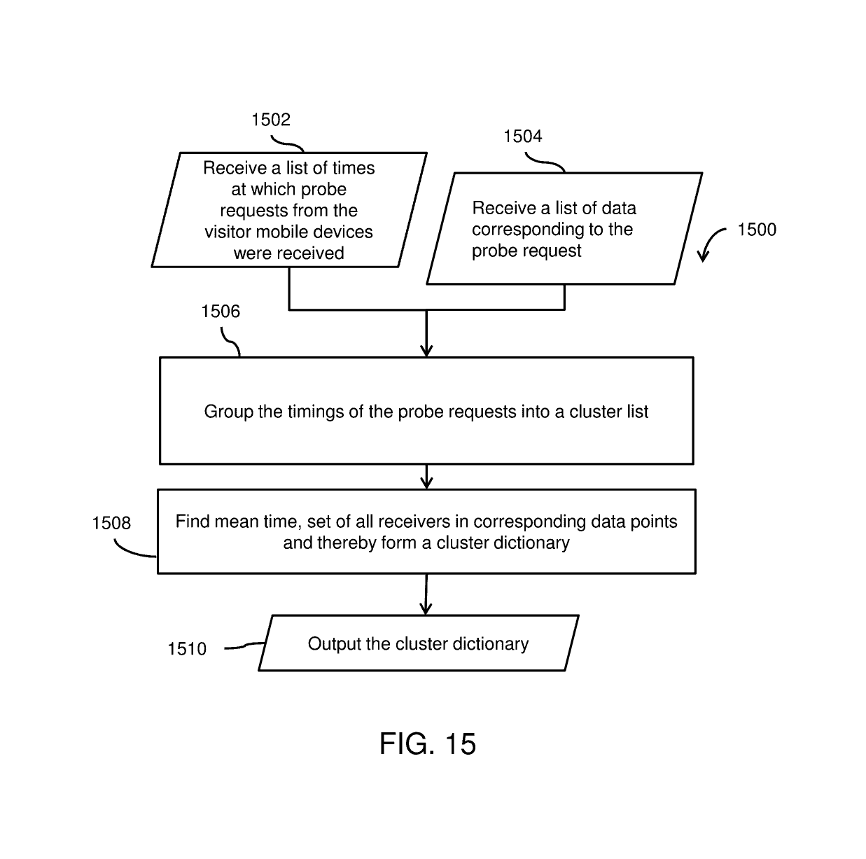

Now referring to FIG. 15, illustrated are actions of an example process 1500 for forming a cluster dictionary for clustering the probe requests received by the receivers 108a-d, in accordance with an embodiment of the present disclosure. Those skilled in the art would recognize that the example process 1500 illustrates actions involved in the operation of a system such as system 200.

At 1502, the server 112 receives a list of different times at which probe requests from the visitor mobile devices 102 were received by receivers 108a-d. Further, at 1504, the server 112 receives a list of data corresponding to the received probe requests. Example data includes but is not limited to date at which the probe requests were received, time at which the probe requests were received, receiver that received that request, MAC address of the visitor mobile device and RSS of the probes.

At 1506, the server 112 groups the timings of the probe requests into a cluster list. In an example, the cluster list is a list of times of the probe requests demonstrating that the probe requests belong to same cluster. For example, clustering can be performed using a hard cut off, such as grouping all the probe requests received within 0.5 seconds of a first probe request. In another embodiment, clustering can be performed by using an alternative clustering algorithm.

At 1508, for each list of times in the cluster list, the server 112 finds mean time and the set of all receivers in corresponding data points to thereby form a cluster dictionary. Further, at 1510, the server 112 outputs the cluster dictionary.

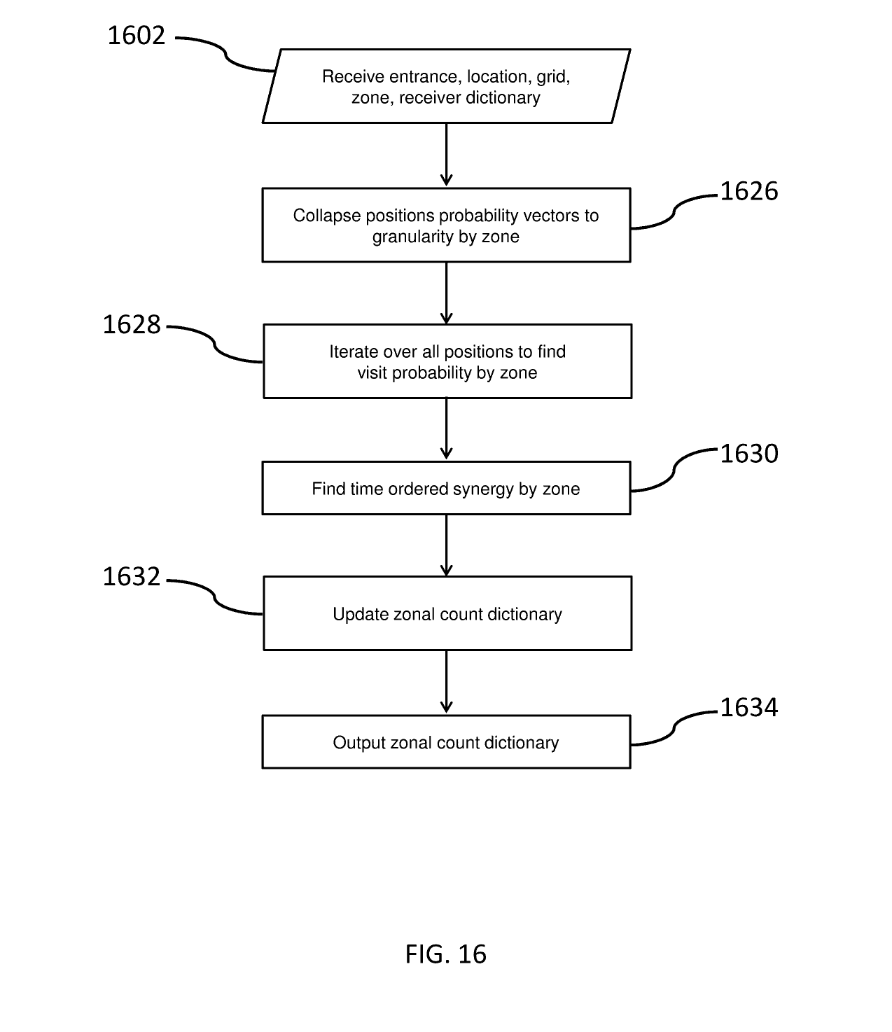

Referring to FIGS. 16-22, illustrated are actions of an example processes for generating a zonal count dictionary, a grid count dictionary, a location count dictionary and an entrance count dictionary, in accordance with an embodiment of the present disclosure. Those skilled in the art would recognize that the example processes illustrate actions involved in the operation of a system such as system 200.

Referring to FIG. 16, illustrated are actions of a first example process 1600 for generating a zonal count dictionary, in accordance with an embodiment of the present disclosure. At 1602, the server 112 receives the plurality of dictionaries, such as, the entrance dictionary, the location dictionary, the grid dictionary, the zone dictionary and the receiver dictionary as input. At 1626, the server 112 collapses position probability vectors to granularity by zone. Since the zone and/or location to which a grid square belongs is known, the position probability vector running over all grid squares can be reduced to a probability vector running over all locations and/or zones allowing computation of visit probability to the granularity of a zone and/or location. Further, at 1628, the server 112 finds a visit probability by zone and iterates over all positions. At 1630, the server 112 finds time ordered synergy by zone. At 1632, the server 112 updates the zonal count dictionary with count, synergy and time ordered synergy including errors. At 1634, the server 112 outputs the zonal count dictionary.

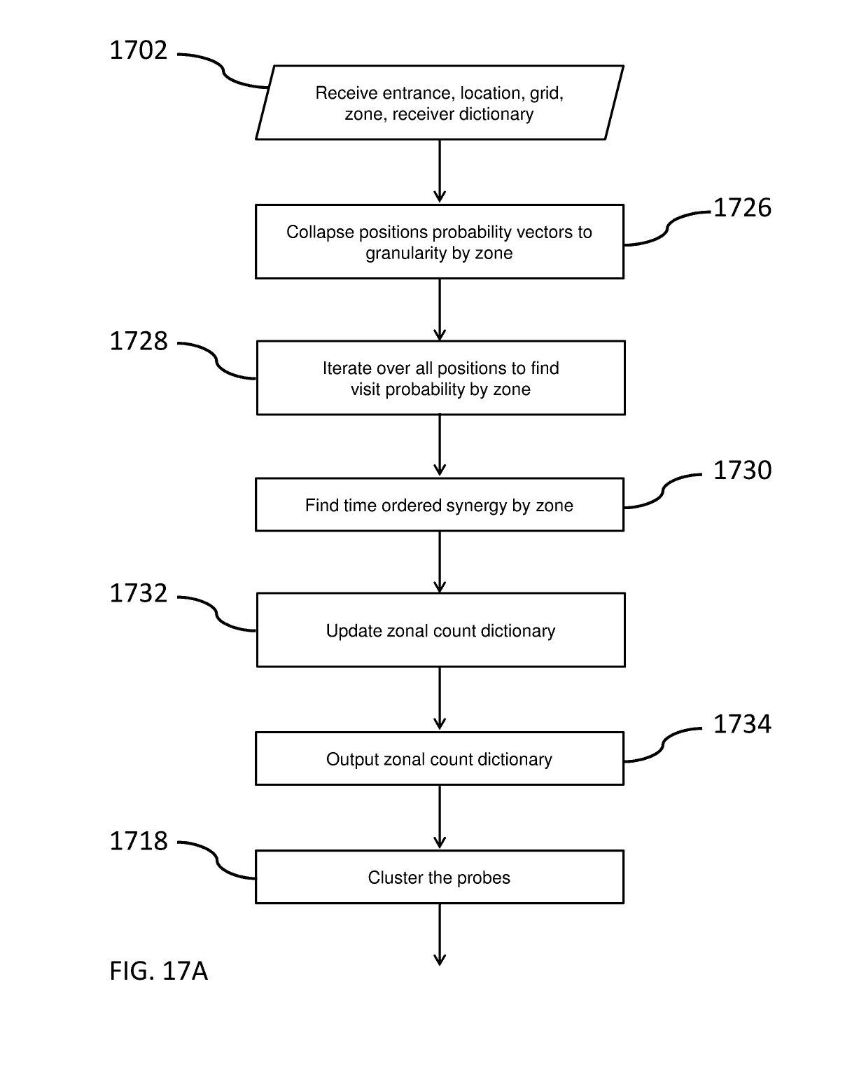

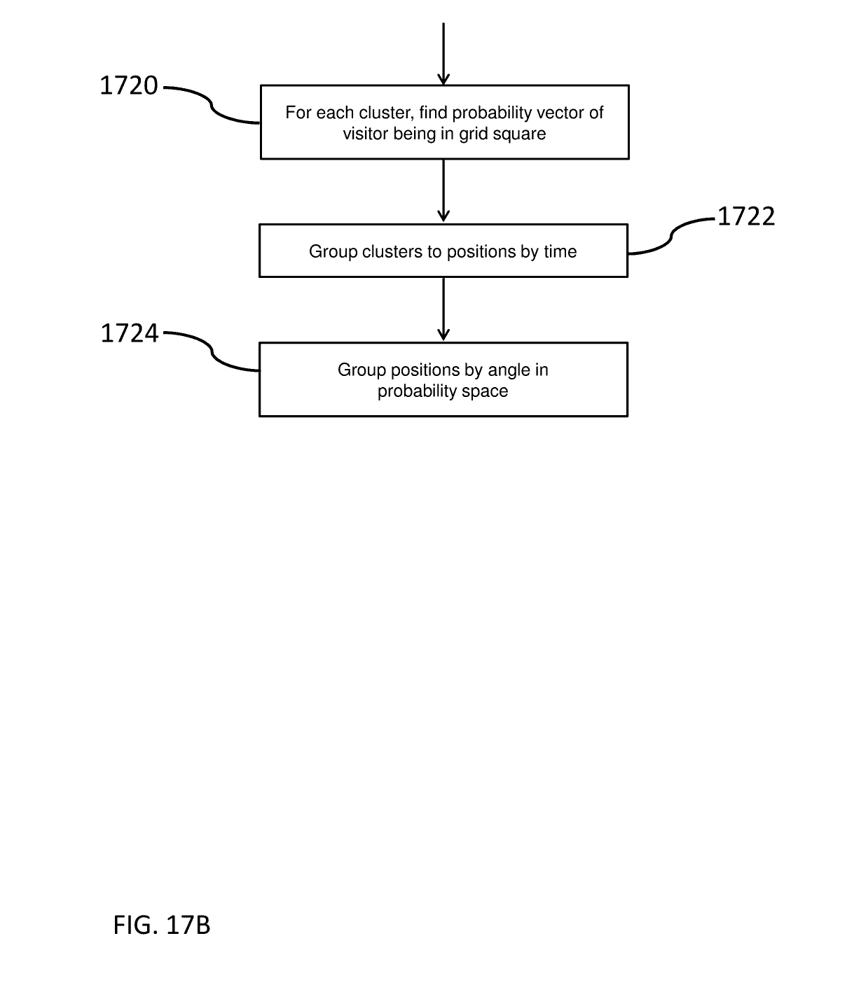

Referring to FIGS. 17A and 17B, illustrated are actions of a second example process 1700 for generating a zonal count dictionary, in accordance with an embodiment of the present disclosure. At 1702, the server 112 receives the plurality of dictionaries, such as, the entrance dictionary, the location dictionary, the grid dictionary, the zone dictionary and the receiver dictionary as input. Further the server 112 collapses position probability vectors to granularity by zone at 1726.

Further, at 1728, the server 112 finds a visit probability by zone and iterates over all positions. At 1730, the server 112 finds time ordered synergy by zone. At 1732, the server 112 updates the zonal count dictionary with count, synergy and time ordered synergy including errors. At 1734, the server 112 outputs the zonal count dictionary. At 1718, the server 112 clusters the probe requests.

At 1720, for each cluster, the server 112, by computing product over all the receivers 108a-d finds the probability vector representing the probability of being in a grid square and outputs a list of cluster times and the corresponding probability vector. At 1722, the server 112 groups the clusters to positions by time and outputs a position list which may be, for example, a list of lists of times, with one probability vector per list, granularity by grid.

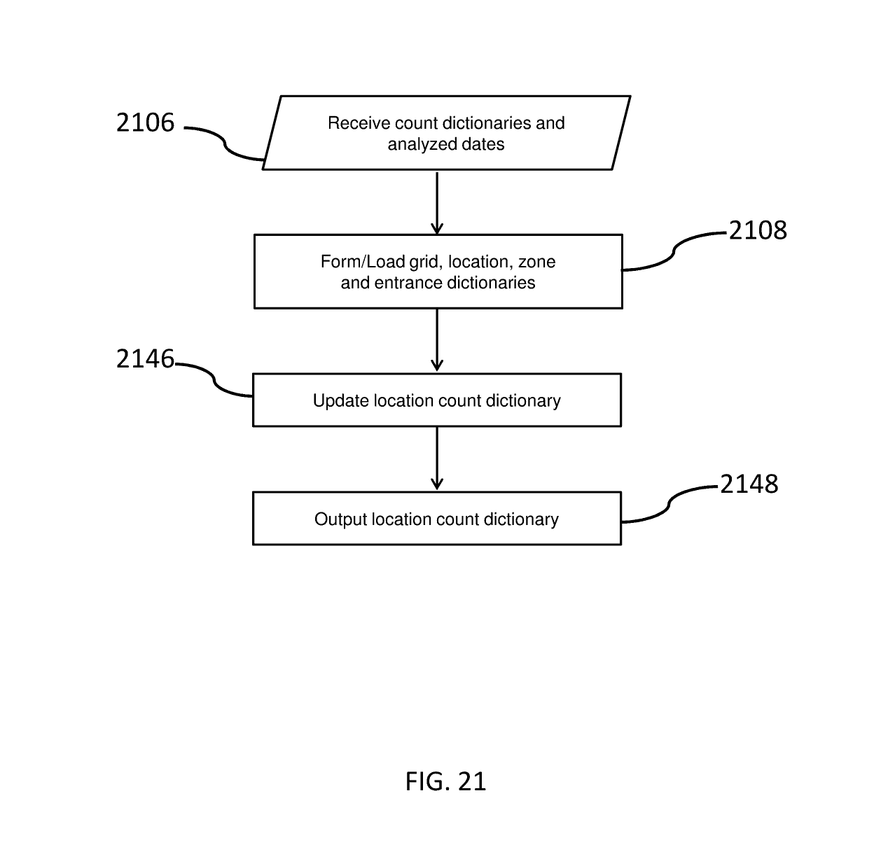

At 1724, the server 112 groups positions by angle in probability space and outputs a position list which may be, for example, a list of lists of times, with one probability vector per list, having granularity by grid. In another example, process 1700 may proceed from grouping positions by angle in probability space to generating an output location count dictionary in accordance with actions such as 2106, 2108, 2146 and 2148 described in greater detail below with reference to process 2100 and FIG. 21.

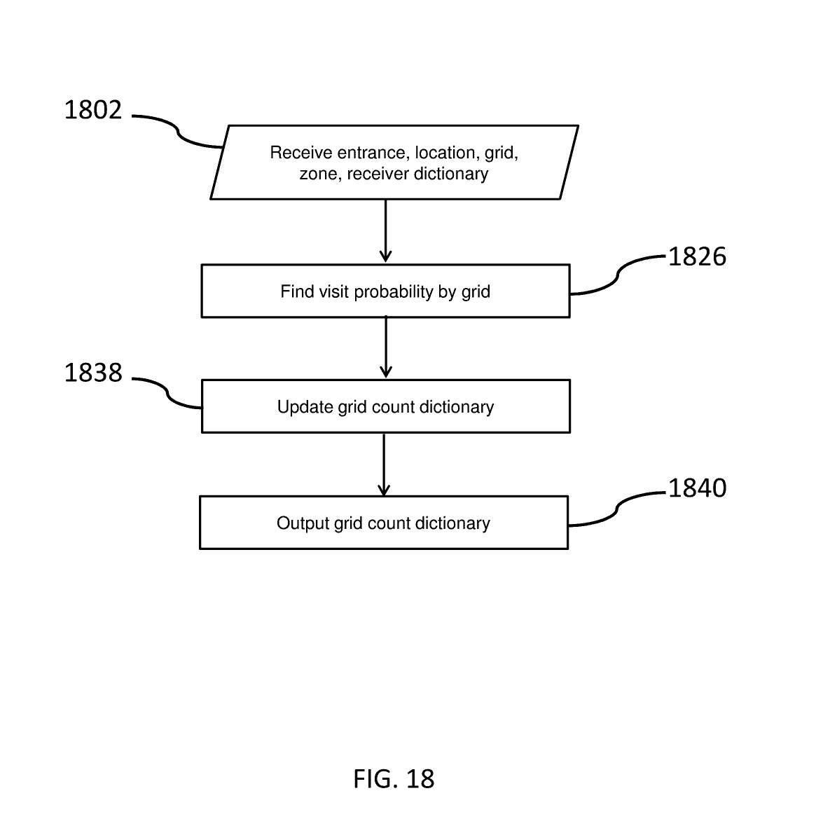

Referring to FIG. 18, illustrated are actions of a third example process 1800 for generating a zonal count dictionary, a grid count dictionary, a location count dictionary and an entrance count dictionary, in accordance with an embodiment of the present disclosure. At 1802, the server 112 receives the plurality of dictionaries, such as, the entrance dictionary, the location dictionary, the grid dictionary, the zone dictionary and the receiver dictionary as input. At 1826, the server 112 collapses position probability vectors to granularity by zone. Further, at 1838, the server 112 updates a grid count dictionary with count including errors. At 1840, the server 112 outputs the grid count dictionary.

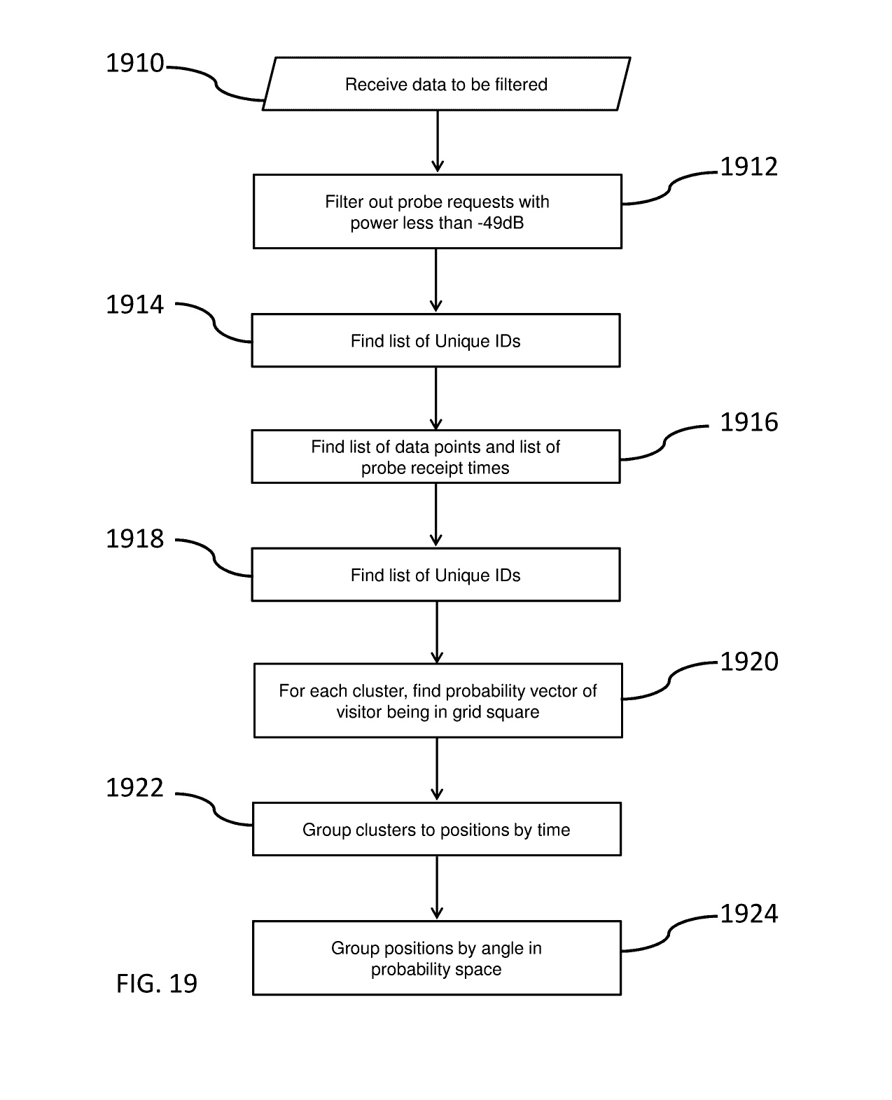

Referring to FIG. 19, illustrated are actions of a fourth example process 1900 for generating a zonal count dictionary, a grid count dictionary, a location count dictionary and an entrance count dictionary, in accordance with an embodiment of the present disclosure. At 1910, the server 112 receives data to be filtered. At 1912, the server 112 filters out the probe requests having power less than −49 dB and those intercepted by a receiver not present in the receiver dictionary. At 1914, the server 112 loops over the filter data and finds a list of unique IDs. At 1916, the server 112 loops over the filtered data for each unique ID and find a list of times the probes were received and a list of data points.

At 1918, the server 112 clusters the probe requests. At 1920, for each cluster, the server 112, by computing product over all the receivers 108a-d finds the probability vector representing the probability of being in a grid square and outputs a list of cluster times and the corresponding probability vector. At 1922, the server 112 groups the clusters to positions by time and outputs a position list which may be, for example, a list of lists of times, with one probability vector per list, granularity by grid. At 1924, the server 112 groups positions by angle in probability space and outputs a position list which may be, for example, a list of lists of times, with one probability vector per list, having granularity by grid. In another example, process 1700 may proceed from grouping positions by angle in probability space to generating an output location count dictionary in accordance with actions such as 2106, 2108, 2146 and 2148 described in greater detail below with reference to process 2100 and FIG. 21.

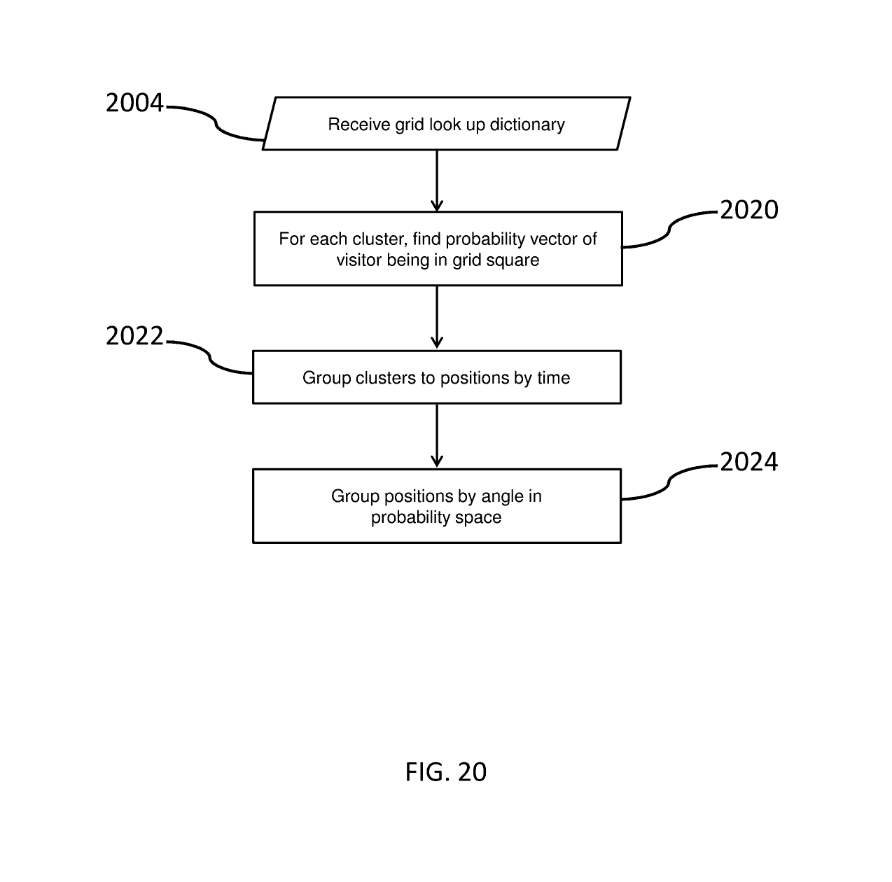

Referring to FIG. 20, illustrated are actions of a fifth example process 2000 for generating a zonal count dictionary, a grid count dictionary, a location count dictionary and an entrance count dictionary, in accordance with an embodiment of the present disclosure. At 2004, the server 112 receives the grid look up dictionary. At 2020, for each cluster, the server 112, by computing product over all the receivers 108a-d finds the probability vector representing the probability of being in a grid square and outputs a list of cluster times and the corresponding probability vector. At 2022, the server 112 groups the clusters to positions by time and outputs a position list which may be, for example, a list of lists of times, with one probability vector per list, granularity by grid. At 2024, the server 112 groups positions by angle in probability space and outputs a position list which may be, for example, a list of lists of times, with one probability vector per list, having granularity by grid. In another example, process 1700 may proceed from grouping positions by angle in probability space to generating an output location count dictionary in accordance with actions such as 2106, 2108, 2146 and 2148 described in greater detail below with reference to process 2100 and FIG. 21.

Referring to FIG. 21, illustrated are actions of an example process 2100 for generating a zonal count dictionary, a grid count dictionary, a location count dictionary and an entrance count dictionary, in accordance with an embodiment of the present disclosure. At 2106, the server 112 receives the count dictionaries and analyzed dates. At 2108, the server 112 loads the grid, location, zone and entrance count dictionaries in case of previously analyzed dates and otherwise form the grid, location, zone, entrance count dictionaries with initial zero values as entries. Further, at 2146, the server 112 updates the location count dictionary with count and synergy including errors. At 2148, the server 112 outputs the location count dictionary.

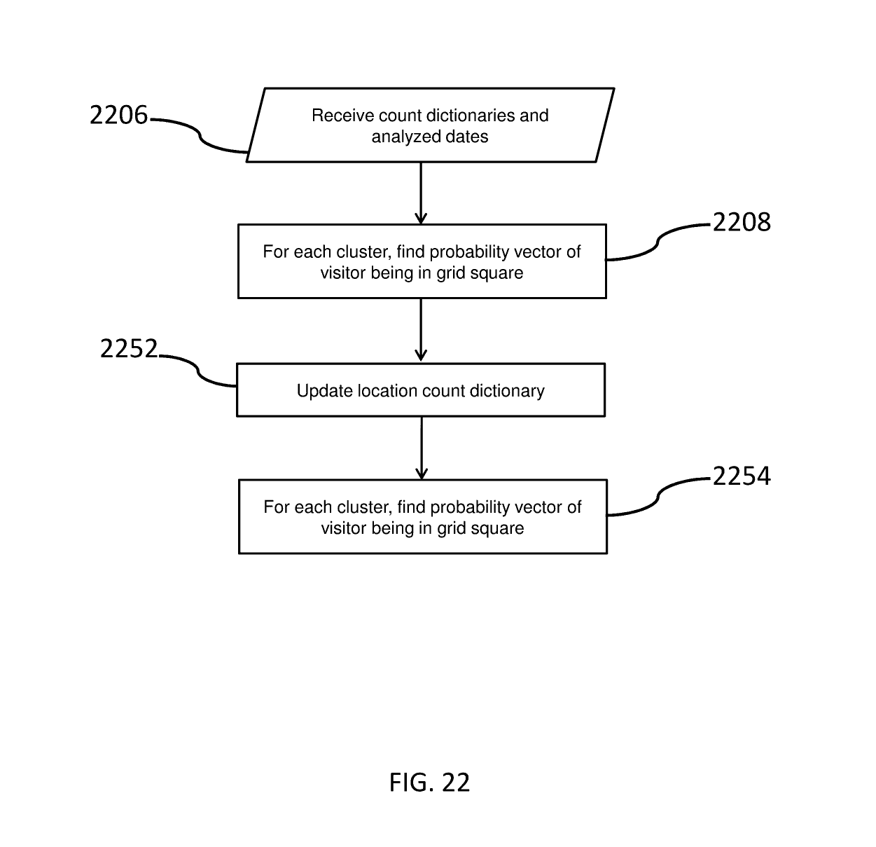

Referring to FIG. 22, illustrated are actions of an example process 2200 for generating a zonal count dictionary, a grid count dictionary, a location count dictionary and an entrance count dictionary, in accordance with an embodiment of the present disclosure. At 2206, the server 112 receives the count dictionaries and analyzed dates. At 2208, the server 112 loads the grid, location, zone and entrance count dictionaries in case of previously analyzed dates and otherwise form the grid, location, zone, entrance count dictionaries with initial zero values as entries. Further, at 2252, the server 112 updates an entrance count dictionary with respective entrance and exit counts including errors. At 2254, the server 112 outputs the entrance count dictionary.

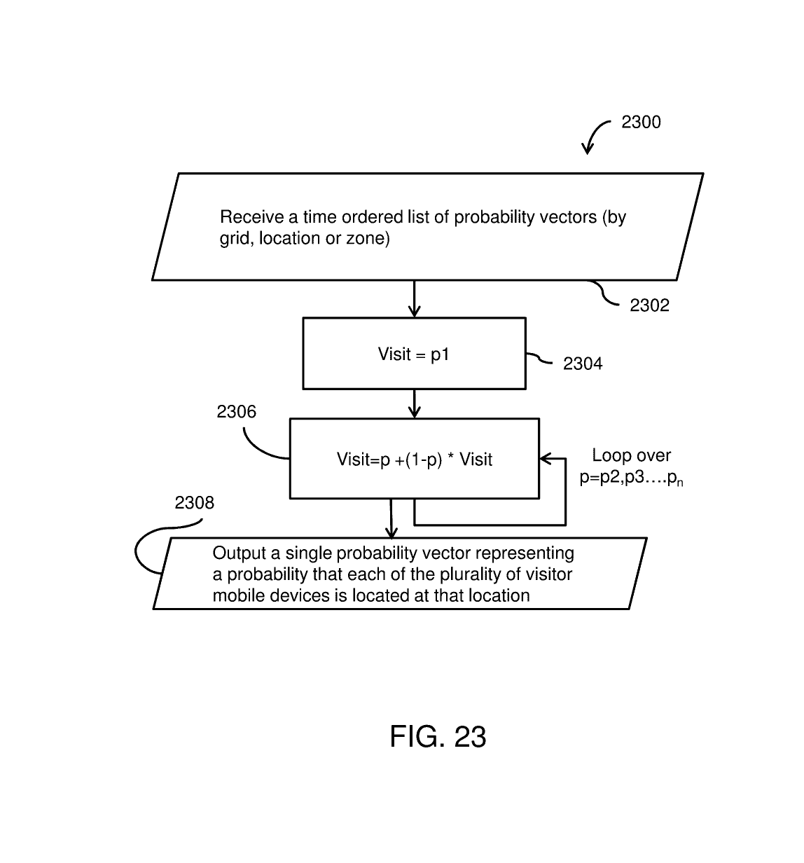

Referring to FIG. 23, illustrated are actions of a method 2300 for calculating a visit probability vector of the visitor mobile devices 102 in a particular location of the one or more locations within the facility 104, in accordance with an embodiment of the present disclosure. Specifically, those skilled in the art would recognize that the method 2300 illustrates actions involved in the operation of the system 200.

At 2302, the server 112 receives a time ordered list of probability vectors (by grid, location or zone). For example, the server 112 receives a time ordered list of n probability vectors:
{p₁, p₂ . . . pₙ}

At 2304, the server 112 initializes each visit of the visitor mobile devices 102 (FIG. 1) with a probability vector of a first device (p₁). Here p₁ denotes a first probability vector representing a probability that each of the plurality of visitor mobile devices 102 is located at that location.

At 2306, the server 112 calculates the visit probability by using the following calculations:

visit=p+(1−p)*visit

Further, the server 112 loops over each of the probability vector except the probability vector of the first device (p₁). Specifically, the server 112 performs the above calculation for other probability vectors (for example, p₂, p₃ . . . pₙ) associated with other visitor mobile devices 102.

At 2308, the server 112 outputs a single probability vector representing a probability that each of the plurality of visitor mobile devices 102 is located at that location.

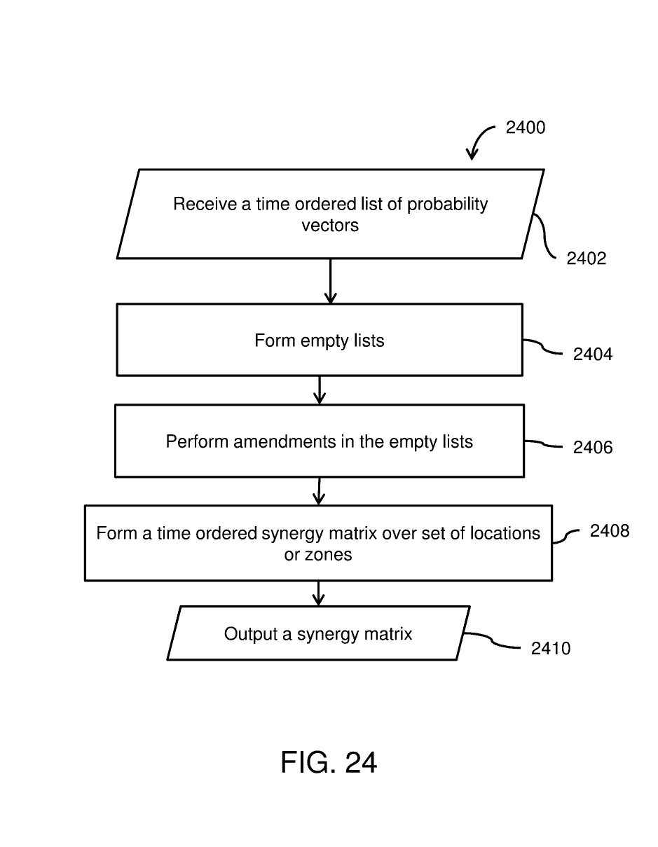

Referring to FIG. 24, illustrated is a schematic of actions of an example process 2400 for calculating a time ordered synergy, in accordance with an embodiment of the present disclosure. Those skilled in the art would recognize that the example process 2400 illustrates actions involved in the operation of a system such as system 200.

The time ordered synergy refers to calculating a number of visitors who visited a first location and then a second location. At 2402, the server 112 receives a time ordered list of the probability vectors (by location or zone). In an example, the server 112 receives a time ordered list of n probability vectors,
{p₁, p₂ . . . pₙ}

At 2404, the server 112 forms empty lists.
Visit_prob_forward_in_time=[ ]
Visit_prob_backwards_in_time=[ ]

At 2406, the server 112 performs amendments in the empty lists, described below:
form=1 . . . n:
append Visit_prob_forward_in_time with Visit probability from {p₁, . . . , pₘ}
append Visit_prob_backwards_in_time with Visit probability from {pₘ, . . . , pₙ}

At 2408, the server 112 forms a time ordered synergy matrix over a set of locations or zones. In an example, synergy is calculated by taking a product of the visit probability vector with diagonals set to zero. At 2410, the server 112 outputs a synergy matrix.

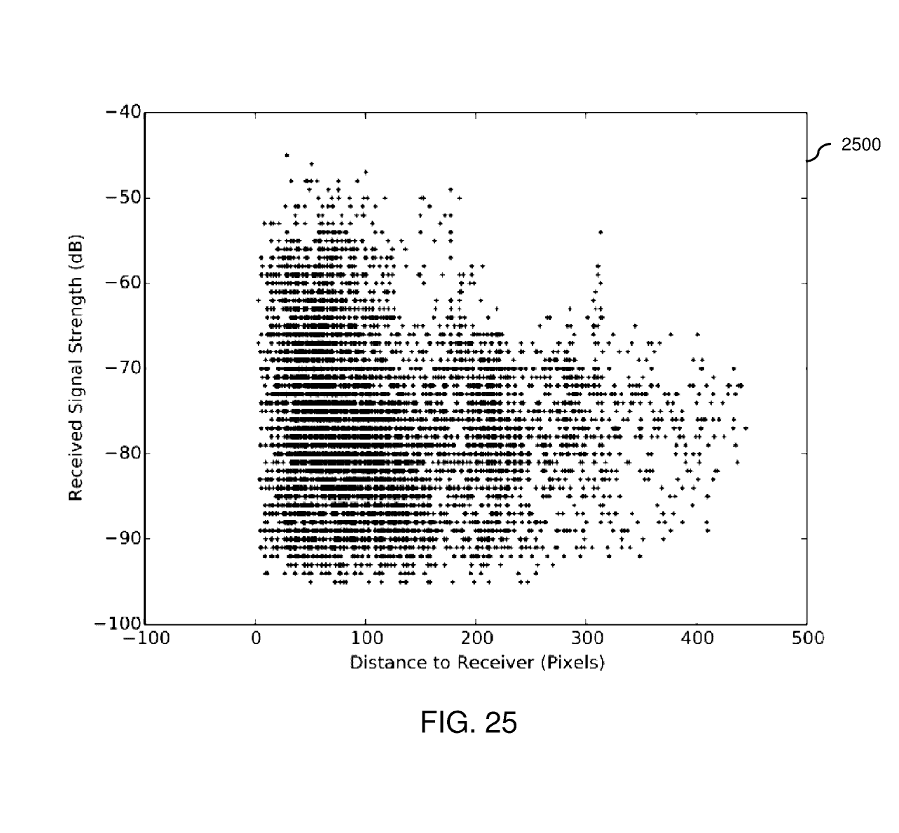

Now referring to FIG. 25, illustrated is a plot 2500 representing example measured RSS of the probe requests (in db), as a function of distance (in pixels), in accordance with an embodiment of the present disclosure. The plot 2500 depicts a significant decrease in the received signal strength with an increase in the distance of the visitor mobile devices 102 from one of receivers 108a-d.

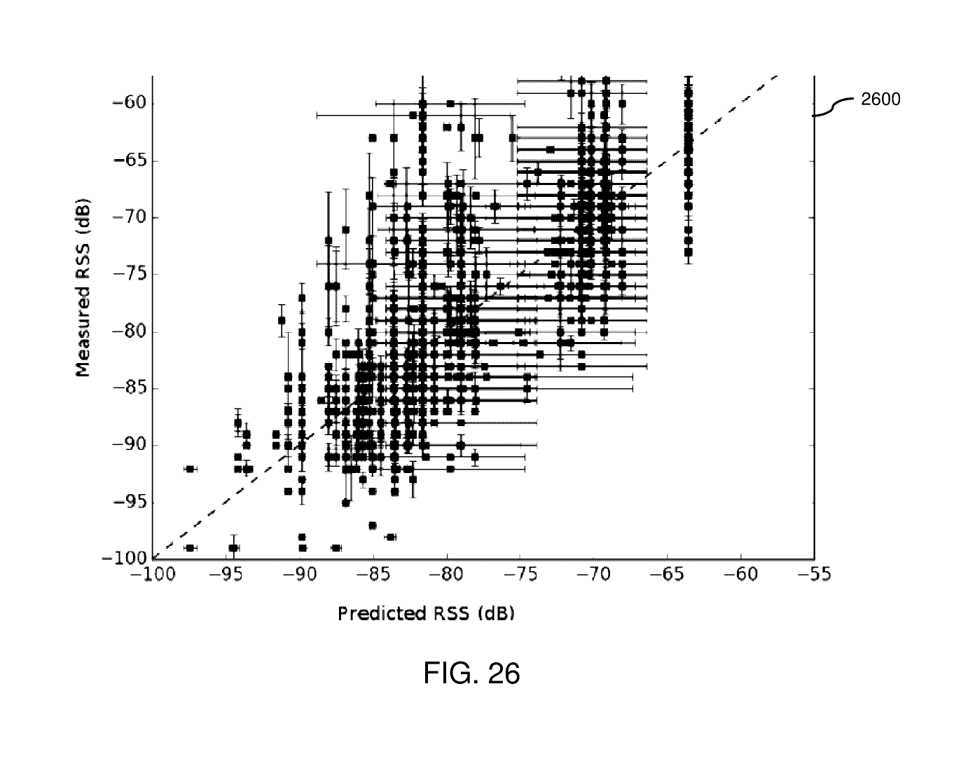

Now referring to FIG. 26, illustrated is a plot 2600 representing measured RSS of the probe requests, as a function of predicted RSS, in accordance with an embodiment of the present disclosure. The predicted RSS is the integer value estimated from the linear regression based model. The measured RSS is based on the RSS of the visitor mobile devices 102 measured by the server 112 based on the probe requests received by any of the receivers 108a-d.

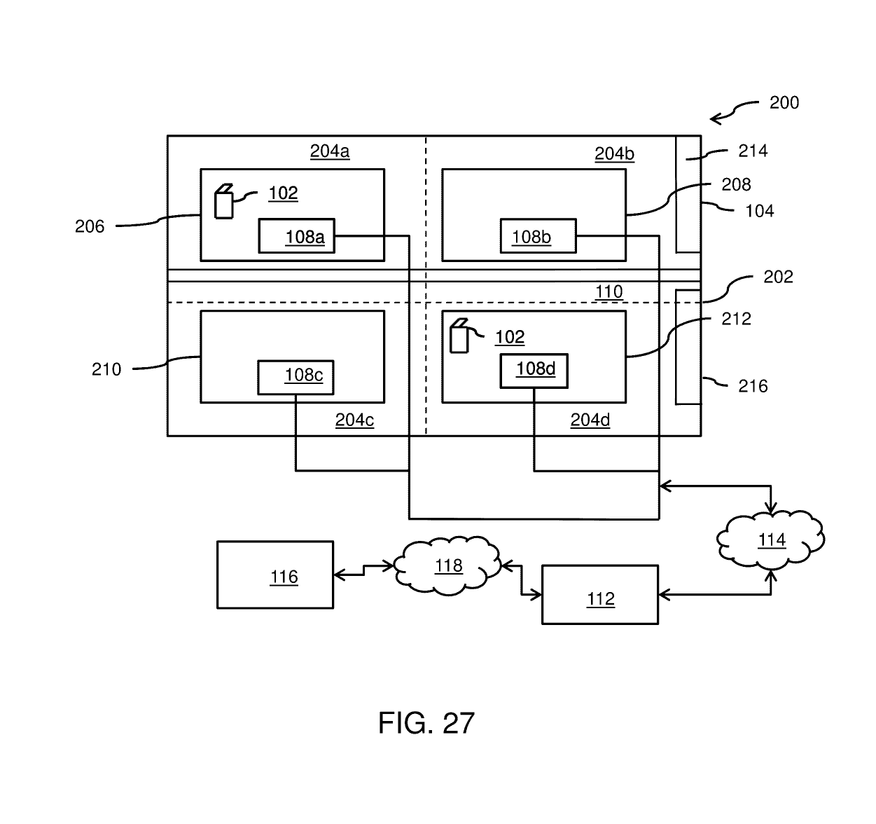

Referring to FIG. 27, illustrated is a schematic of an example embodiment of the system 200 for representing density of the visitor mobile devices 102 in the one or more locations of the facility 104, in accordance with an embodiment of the present disclosure. Locations 206 and 212 are shaded to represent the density of the visitor mobile devices 102 in the respective locations. In an instance, it depicts a maximum density of the mobile devices at the location 206 of the facility 104. Further, the example embodiment depicts the minimum density of the visitor mobile devices 102 at the location 212 of the facility 104.

Specifically, the density of the visitor mobile devices 102 shows the number of shoppers in the one or more locations of the facility 104. The location 206 has maximum shoppers in it, while the location 212 has the minimum shoppers. This data can be used for monitoring the behavior of shoppers in the one or more locations (such as, stores) of the facility 104. Further, this data can be used to count the number of visitor mobile devices 102 visiting each of the location 206 and 212, for the purpose of business analytics.

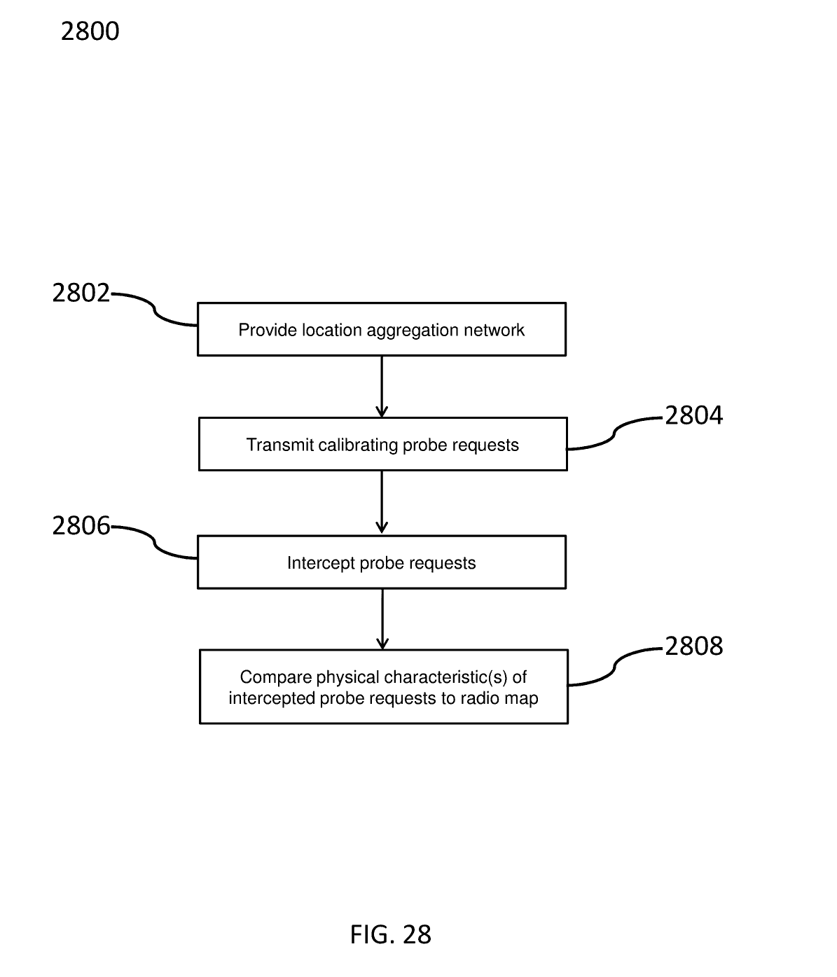

Referring to FIG. 28, illustrated are actions of a method 2800 for aggregating the number of visitor mobile devices 102 visiting the one or more locations within the facility 104, in accordance with an embodiment of the present disclosure. Those skilled in the art would recognize that the process 2800 illustrates actions involved in the operation of a system such as the system 200.

At 2802, a location aggregation network, including a plurality of receivers, is provided to a facility.

At 2804, a burst of calibrating probe requests is transmitted from one or more mobile calibration devices at the one or more locations to one or more of the plurality of receivers in order to calibrate the location aggregation network and form a radio map of the facility.

At 2806, probe requests from a plurality of visitor mobile devices are intercepted at one or more of the receivers.

At 2808, at least one physical characteristic of the intercepted probe requests is compared to physical characteristic values of the radio map to yield, associated with each location for each receiver, a vector representing a probability that each of the plurality of visitor mobile devices is located at that location.

The actions 2804 to 2808 are only illustrative and other alternatives can also be provided where one or more actions are added, one or more actions are removed, or one or more actions are provided in a different sequence without departing from the scope of the claims herein. For example, the process 2800 can further include from the probability vectors, computing for each location, a time-independent probability that any visitor mobile device visits the location during a trip to the facility. In another example, the process 2800 can further include from the probabilities of a visitor mobile device visiting the locations, computing the number of visitor mobile devices which visited a first one of the locations and subsequently visited a second one of the locations. In another example, the process 2800 can further include filtering out from the intercepted visitor mobile device probe requests with the one or more receivers, at least one of: signals from devices passing by the facility, randomized MAC addresses and fixed devices. In another example, the process 2800 can further include clustering the intercepted probe requests according to MAC address.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for aggregating a quantity of visitor mobile devices visiting any of a number of locations within a facility, comprising:
providing a location aggregation network to the facility, wherein the location aggregation network includes a plurality of receivers;
transmitting a burst of calibrating probe requests from one or more mobile calibration devices at positions within the number of locations to one or more of the receivers in order to form a radio map of the facility;
intercepting probe requests from one or more of the visitor mobile devices at one or more of the receivers; and
comparing at least one physical characteristic of the intercepted probe requests to physical characteristic values of the radio map to yield, associated with each of the plurality of receivers, a vector representing a probability for each of the number of locations that a visitor mobile device from which at least one probe request has been intercepted visited those locations.

2. The method as set forth in claim 1, further comprising, from the probability vectors, computing for each location, a time-independent probability that any visitor mobile device visits the location during a trip to the facility.

3. The method as set forth in claim 2, further comprising:
from the time-independent probabilities, computing the number of visitor mobile devices which visited a first of the one or more locations and subsequently visited a second of the one or more locations.

4. The method as set forth in claim 1, wherein calibrating the location aggregation network to form the radio map further comprises relating at least one physical characteristic of the calibrating probe requests to known distances of the mobile calibrating devices from the one or more receivers.

5. The method as set forth in claim 4, wherein calibrating the location aggregation network to form the radio map further comprises imposing attributes of a scalable vector graphics map of the facility to the known distances.

6. The method as set forth in claim 1, wherein each of the one or more locations are represented on the radio map with a fingerprint, the method further comprising quantifying a bias resulting from more than one location having a given fingerprint.

7. The method as set forth in claim 1, further comprising, with the one or more receivers, filtering out from the intercepted probe requests at least one of: signals from devices passing by the facility, randomized MAC addresses and fixed devices.

8. The method as set forth in claim 1, further comprising clustering the intercepted probe requests according to MAC address.

9. The method as set forth in claim 1, wherein providing the location aggregation network to the facility further comprises fixing the one or more receivers of the location aggregation network at known locations.

10. A system for aggregating a quantity of visitor mobile devices visiting any of a number of locations within a facility, comprising:
one or more mobile calibrating devices configured to transmit a burst of calibrating probe requests from positions within the number of locations in order to calibrate the system and form a radio map of the facility;
a plurality of receivers configured to receive the calibrating probe requests from one or more of the mobile calibrating devices and intercept probe requests from the visitor mobile devices; and
at least one server configured to compare at least one physical characteristic of probe requests intercepted from one or more of the visitor mobile devices to the radio map to yield, associated with each of the plurality of receivers, a vector representing a probability for each of the number of locations that a visitor mobile device from which at least one probe request has been intercepted visited those locations.

11. The system as set forth in claim 10, wherein the at least one server is further configured to compute, from the probability vectors, for each of the number of locations, a time-independent probability that the visitor mobile device visits that location during a trip to the facility.

12. The system as set forth in claim 11, wherein the at least one server is further configured to compute, from the time-independent probabilities, the quantity of visitor mobile devices which visited a first location of the number of locations and subsequently visited a second location of the number of locations.

13. The system as set forth in claim 10, wherein the at least one server is further configured to, during formation of the radio map, relate at least one physical characteristic of the calibrating probe requests to known distances of the one or more mobile calibrating devices from the plurality of receivers.

14. The system as set forth in claim 13, wherein the at least one server is further configured to, during formation of the radio map, impose attributes of a scalable vector graphics map of the facility to the known distances.

15. The system as set forth in claim 10, wherein each of the number of locations are represented on the radio map with a fingerprint, and wherein the at least one server is further configured to quantify a bias resulting from two or more of the number of locations having a single fingerprint.

16. The system as set forth in claim 10, wherein the plurality of receivers are further configured to filter out, from the intercepted probe requests, at least one of: signals from devices passing by the facility, randomized MAC addresses and fixed devices.

17. The system as set forth in claim 10, wherein the plurality of receivers are further configured to cluster the intercepted probe requests according to MAC address.

18. The system as set forth in claim 10, wherein the positions of the plurality of receivers of the location aggregation network are fixed within the facility.

19. A method for aggregating a quantity of visitor mobile devices visiting any of a number of locations within a facility, comprising:
intercepting probe requests from a plurality of visitor mobile devices at a plurality of receivers of a location aggregation network;
comparing a received signal strength of probe requests intercepted from one or more of the visitor mobile devices to a received signal strength predictive model to yield, associated with each of the plurality of receivers, a vector representing a probability for each of the number of locations that a visitor mobile device from which at least one probe request has been intercepted visited those locations; and
from the probability vectors, computing, for each location, a time-independent probability that any visitor mobile device visits that location during a trip to the facility.

20. The method as set forth in claim 19, wherein the received signal strength predictive model incorporates attributes of a scalable vector graphics map to account for walls and floors of the facility existing between the number of locations and each of the plurality of receivers.
